(19) United States
(12) Patent Application Publication
(10) Pub. No.: US 2005/0160465 A1
(43) Pub. Date: Jul. 21, 2005

(54) Interactive television system with automatic switching from broadcast media to streaming media

(75) Inventor: Todd A. Walker, Bixby, OK (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: UNITED VIDEO PROPERTIES, INC., Tulsa, OK (US)

(21) Appl. No.: 10/763,007

(22) Filed: Jan. 21, 2004

(51) Int. Cl. H04N 5/445; G06F 13/00; G06F 3/00; H04N 7/173

(52) U.S. Cl. 725/86; 725/87; 725/39

(57) ABSTRACT

An interactive television system is provided in which a user may perform playback control functions while watching a broadcast television program. When the user requests such a function, a television distribution facility may transmit an interactive streaming media version of the program to the user's equipment. The user equipment switches the broadcast television program with the interactive streaming media version. The interactive streaming media version, once displayed on the given user's user equipment, may be controlled by the user with playback control functions.

### BACKGROUND OF THE INVENTION

This invention relates to television systems, and more particularly, to interactive television systems that provide broadcast television programming and streaming media programming.

Interactive television systems are known to provide interactive television program guide applications. An interactive television program guide application may be configured to provide a number of interactive features such as television program listings, video-on-demand services, web-browsing services, games, home shopping, and other interactive features, to the user.

In a typical interactive television system, the interactive television program guide application is implemented on a set-top box. The user interacts with the interactive television program guide application, for example, to access broadcast programming and associated content and to request playback control functions, using a remote control.

In a computer environment, the user accesses an online interactive television program guide application to obtain desired information such as information associated with available broadcast programming.

Television programming that is broadcast to a user and displayed on the user equipment is generally non-interactive. While the user is viewing the broadcast television programming, the user is generally unable to control the playback of the program, such as pausing, rewinding, fast-forwarding, or other such features traditionally available for recorded programs or streaming media programs (e.g., video-on-demand).

Using the functions of a personal video recorder, a user can pause live broadcast television. However, such functions are generally not available to users who do not have personal video recorders or other special equipment in their homes.

Although playback control features are available to a user if the broadcast program is being concurrently cached (e.g., by storage on a network-based or local personal video recorder), the cache is generally limited to the portion of the program that has been broadcast, and thus cannot be “fast-forwarded” or skipped beyond the current time.

It would therefore be desirable to provide television programming via broadcast while providing the user with a variety of playback control functions upon request by the user.

It would also be desirable to provide a user with on-demand playback control functions, such as the ability to pause, rewind, fast-forward, etc., while viewing a broadcast television program.

### SUMMARY OF THE INVENTION

In accordance with the present invention, interactive television systems are provided that allow a user to request playback control functions while viewing broadcast television programs on the user equipment. During normal television viewing, a broadcast television program is provided to and displayed on the user equipment. A streaming version of the broadcast program is provided to a television distribution facility in advance of the broadcast. When the user requests a playback control function (e.g., pause, resume, play, rewind, fast-forward, slow forward, slow reverse, jump to another time point, skip, scan, frame-by-frame advance, frame backward, restart program, etc.) while viewing the broadcast program, the system may be directed to switch from displaying the broadcast television program on the user equipment to displaying the streaming version of the program. The system may be configured to perform the switch at the substantially the same time point of the respective program versions, such that the switch may appear essentially seamless from the perspective of the user viewing the program.

Once the system has switched to displaying the streaming version of the television program on the user equipment, the streaming version may be responsive to further requests by the user for playback control functions, such as pause, resume, play, rewind, skip, fast forward, jump to another time point, slow forward, slow reverse, scan, frame-by-frame reverse, frame backward, restart program, etc.

When such a function is initiated by the viewer (e.g., when the user presses an appropriate remote control button to pause the broadcast program), an interactive application on the user equipment may identify which program or channel is being viewed and may provide this information to equipment at the television distribution facility.

Upon receiving the user's request for a playback control function, the interactive television system may determine the time point in the broadcast television program at which the request occurred. This time point may be used to determine the corresponding time point at which to begin displaying of the streaming version. The system may determine this time point by, for example, determining the amount of time elapsed in the broadcast, by identifying an embedding index or marker in the program, or other suitable methods or combinations thereof.

After the switch to displaying the streaming version of the program on the user equipment, the user may continue to view the program as a streaming version, essentially unaware of the seamless transition between the two versions. While viewing the streaming version, the user may continue to use pause, fast-forward, rewind and various other playback control functions and the distribution facility will respond accordingly by streaming the appropriate portion of the program to the user based on the user's commands. The user may direct the interactive television application to resume displaying the broadcast television program (i.e., switching back to the broadcast), or the broadcast may automatically resume once the program being viewed reaches its end.

Because a user may not request a playback control function with every broadcast television program that she views, the present invention may be provided to the user as a premium service. In such an example, a fee may be charged to the user for the user of playback control function (e.g., a fee per use, a subscription fee, etc.). In some embodiments, the playback control features may be available for all programs or channels, or a limited set of programs or channels.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive television system in accordance with various embodiments of the present invention.

FIG. 2 is a diagram of illustrative user television equipment in accordance with various embodiments of the present invention.

FIG. 3 is a diagram of additional illustrative user television equipment in accordance with various embodiments of the present invention.

FIG. 4 is a diagram of an illustrative remote control in accordance with various embodiments of the present invention.

FIG. 5 is a diagram of illustrative user computer equipment in accordance with various embodiments of the present invention.

FIG. 6 is a generalized diagram of illustrative user equipment in accordance with various embodiments of the present invention.

FIG. 7 shows an illustrative menu screen in accordance with various embodiments of the present invention.

FIG. 8 shows an illustrative program guide screen in accordance with various embodiments of the present invention.

FIG. 9 is an illustrative display screen showing how a flip banner that contains program listings information for the current channel may be displayed as an overlay over video of the current channel in accordance with various embodiments of the present invention.

FIG. 10 is an illustrative display screen showing how a browse banner that contains program listings information for a channel that may differ from the current channel may be displayed as an overlay over video of the current channel in accordance with various embodiments of the present invention.

FIG. 11 shows an illustrative program guide screen in accordance with various embodiments of the present invention.

FIG. 12 is an illustrative display screen showing how an interactive television application may provide a user with an opportunity to set a program reminder in accordance with various embodiments of the present invention.

FIG. 13 is an illustrative display screen showing how a reminder may be provided for a user in accordance with various embodiments of the present invention.

FIG. 14 is a display screen showing an illustrative video-on-demand menu that may be used to select a category of video-on-demand content in accordance with various embodiments of the present invention.

FIG. 15 is a display screen showing an illustrative video-on-demand menu screen that may be used to locate a desired type of movie in accordance with various embodiments of the present invention.

FIG. 16 shows an illustrative title menu that may be used to select a video-on-demand title of interest in accordance with various embodiments of the present invention.

FIGS. 17a and 17b are illustrative video-on-demand information screens that may be used to access video-on-demand content in accordance with various embodiments of the present invention.

FIG. 18 is an illustrative display screen showing how video-on-demand playback controls may be displayed while video-on-demand content is being displayed for the user in accordance with various embodiments of the present invention.

FIGS. 19a and 19b are illustrative display screens showing how a user's scheduled recordings may be presented and selected in an interactive list in accordance with various embodiments of the present invention.

FIGS. 20a and 20b are illustrative display screens showing how a user's recordings may be presented and selected from an interactive list in accordance with various embodiments of the present invention.

FIG. 21 is an illustrative display screen showing how video for a recording selected from the list of FIG. 18 may be displayed for the user in accordance with various embodiments of the present invention.

FIG. 22 is an illustrative display screen showing how the user may be provided with options that allow the user to schedule a recording of a desired program in accordance with various embodiments of the present invention.

FIG. 23a is an illustrative display screen showing how a user may set parental controls for a given program in accordance with various embodiments of the present invention.

FIG. 23b is an illustrative display screen showing how a user may block content by creating a time-based parental control setting in accordance with various embodiments of the present invention.

FIG. 24 is an illustrative display screen showing a program during the paused state and providing the user with the opportunity to perform additional playback control functions in accordance with various embodiments of the present invention.

FIG. 25 is an illustrative display screen showing a streaming program with an overlay of user-selectable playback control functions in accordance with various embodiments of the present invention.

FIG. 26 is an illustrative display screen showing a broadcast program with an overlay prompting the user to confirm their activation of a playback control function in accordance with various embodiments of the present invention.

FIG. 27 is a flow chart of illustrative steps involved in using an interactive television system to allow the user to perform playback control functions by switching from providing broadcast to streaming programming content.

### DETAILED DESCRIPTION OF THE PREFERRED EMBODIMENTS

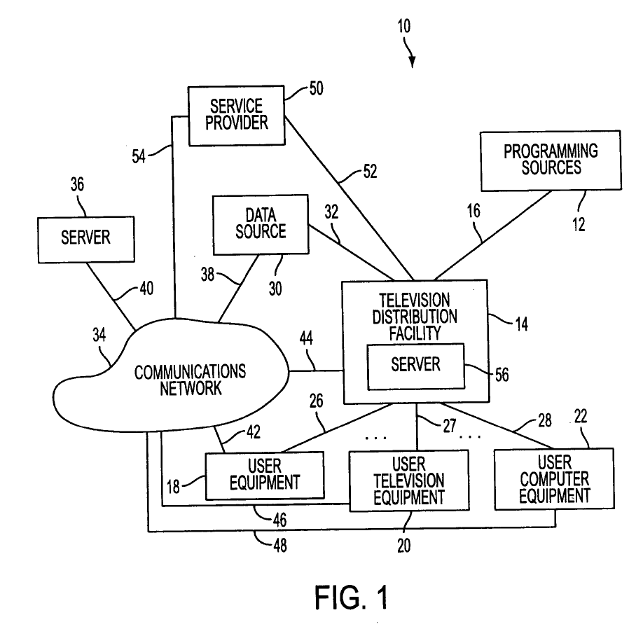

An illustrative interactive television system 10 in accordance with the present invention is shown in FIG. 1. Content such as television programming and other media, such as digital music, may be provided from programming sources 12 to television distribution facilities such as television distribution facility 14 using communications path 16. Programming sources 12 may be any suitable sources of programming (such as television programming, music programming, and other content) such as television and music production studios, etc.

Television distribution facility 14 may be a cable system headend, a satellite television distribution facility, a television broadcast facility, or any other suitable facility for distributing television or music programming to users. There are typically numerous television distribution facilities 14 in system 10, but only one is shown in FIG. 1 to avoid overcomplicating the drawings.

Communications path 16 may be a satellite path, a fiber-optic path, a cable path, or any other suitable wired or wireless communications paths or a combination of such paths.

Television distribution facility 14 may be connected to various user equipment devices 18. Such user equipment 18 may, for example, be located in the homes of users. User equipment 18 may include user television equipment 20 or user computer equipment 22.

The user equipment may receive television and music programming and other information from television distribution facility 14 over communications paths such as communications paths 26, 27, and 28. The user equipment may also transmit signals to television distribution facility 14 over paths 26, 27, and 28. Paths 26, 27, and 28 may be cables or other wired connections, or wireless connections for broadcast or satellite links.

Data source 30 may include a program listings database that is used to provide the user equipment with information for the interactive television program guide, such as scheduled broadcast times, titles, channels, ratings information (e.g., parental ratings and critic's ratings), detailed title descriptions, genre or category information (e.g., sports, news, movies, etc.), information on actors and actresses, running times, etc. Data source 30 may also be used to provide advertisements (e.g., program guide advertisements and advertisements for other interactive television applications), real-time data such as sports scores, stock quotes, news, weather, etc. Although data source 30 is drawn as an individual box in FIG. 1, data source 30 and the other system components of FIG. 1 may be provided using equipment at one or more locations. Systems components are drawn as single boxes in FIG. 1 to avoid over-complicating the drawings.

Data source 30 may provide program schedule information and other data to television distribution facility 14 over communications path 32 for distribution to the associated user equipment over paths 26, 27, and 28. Communications path 32 may be any suitable communications path such as a satellite communications path or other wireless path, a fiber-optic or other wired communications path, a path that supports Internet communications, a combination of such paths, etc. Data source 30 may provide program schedule information and other data to the user at user equipment 18 over path 38, communications network 34, and path 42. Path 42 may be a wired path such as a telephone line, a cable path, a fiber-optic path, a satellite path, a wireless path, a combination of such paths, or any other suitable path.

User equipment devices such as user television equipment and personal computers may use the program schedule information to display program listings and information on digital music for the user. An interactive television program guide application or other suitable application may be used to display such information on the user's display.

An on-line program guide and other interactive television services may be provided using a server connected to communications network 34 such as server 36. Server 36 may receive program schedule information and other data from data source 30 via communications path 38, communications network 34, and communications path 40. Paths 38 and 40 may be satellite paths, fiber-optic paths, wired paths, etc. Communications network 34 may be any suitable communications network, such as the Internet, the public switched telephone network, a packet-based network, etc.

User equipment 18 may access on-line program guide information and other information from server 36 via communications path 42. User equipment 18 may also access the on-line program guide and other services on server 36 via communications path 26, television distribution facility 14, and communications path 44. For example, a cable modem or other suitable equipment may be used by user equipment 18 to communicate with television distribution facility 14. Television distribution facility 14 may communicate with communications network 34 over any suitable path 44, such as a wired path, a cable path, a fiber-optic path, a satellite path, a wireless path, a combination of such paths, etc.

User equipment such as user television equipment 20 and user computer equipment 22 may access the on-line program guide and server 36 using similar arrangements. User television equipment 20 may access the on-line program guide and server 36 using communications path 46 or using path 27, television distribution facility 14, and path 44. User computer equipment 22 may access the on-line program guide and server 36 using communications path 48 or using path 28, television distribution facility 14, and path 44. Paths 46 and 48 may be any suitable paths, such as wired paths, cable paths, fiber-optic paths, satellite paths, wireless paths, a combination of such paths, etc.

Program guide application functions and the functions of other interactive television applications may be supported using server 36 and other servers connected to communications network 34 such as server 56. Interactive television applications may also be supported by servers or other suitable equipment at one or more service providers such as service provider 50. For example, a home shopping service may be supported by a service provider such as service provider 50 that has sales representatives, order fulfillment facilities, account maintenance facilities, and other equipment for supporting interactive home shopping features. A home shopping application that is implemented using the user equipment may be used to access the service provider to provide these features to the user. The user equipment may access service provider 50 via television distribution facility 14 and communications path 52 or via communications network 34 and communications path 54. Communications paths such as paths 52 and 54 may be any suitable paths, such as wired paths, cable paths, fiber-optic paths, satellite paths, wireless paths, a combination of such paths, etc.

Another example of an interactive television application is a home banking application. A home banking service may be supported using personnel at facilities such as service provider 50. An interactive home banking application that is implemented using the user equipment may access the home banking service via television distribution facility 14 and communications path 52 or via communications network 34 and communications path 54.

If desired, an interactive television application such as a client for a network-based video recorder or a video-on-demand application may be supported using server 56, server 36, or equipment at service provider 50. Video-on-demand content and video recorded using a network-based video recorder arrangement may be stored on server 56 or server 36 or at service provider 50 and may be provided to the user equipment when requested by users. An interactive television application may be used to support the functions of a personal video recorder (sometimes called a digital video recorder) that is implemented using user equipment 18. Illustrative equipment that may be used to support personal video recorder functions include specialized personal video recorder devices, integrated receiver decoders (IRDs), set-top boxes with integrated or external hard drives, or personal computers with video recording capabilities.

If desired, applications such as the interactive television program guide application, a home shopping application, a home banking application, a video-on-demand application, game applications, and other applications (e.g., applications related to e-mail and chat or other communications functions, etc.) may be provided as separate applications that are accessed through a navigation shell application (i.e., a menu application with menu options corresponding to the applications). The features of such applications may be combined. For example, games, video-on-demand services, home shopping, network-based video recorder functions, personal video recorder functions, navigational functions, program guide functions, communications functions, and other suitable functions may be provided using one application or any other suitable number of applications.

Moreover, the interactive television program guide application, the home banking application, the home shopping application, the network-based video recorder and personal video recorder applications, the video-on-demand application, the gaming applications, communications applications, and navigational applications, are only a few illustrative examples of the types of interactive television applications that may be supported by system 10. Other suitable applications that may be supported include, news services, web browsing and other Internet services, and interactive wagering services (e.g., for wagering on horse races and the like).

The interactive television application or applications that are used in interactive television system 10 may be implemented locally on the user equipment. The applications may also be implemented in a distributed fashion (e.g., using a client-server architecture in which the user equipment serves at least partly and for at least some of the time, as the client and a server such as server 56 at television distribution facility 14, server 36, or other suitable equipment acts as the server). Other distributed architectures may also be used if desired. Moreover, some or all of the interactive television system features of system 10 may be provided using operating system software or middleware software. Such operating system software and middleware may be used instead of or in combination with application-level software. Regardless of the particular arrangement used to implement interactive television features related to program guides, home shopping, home banking, video-on-demand, Internet, communications, etc., the software that supports these features may be referred to as an application or applications.

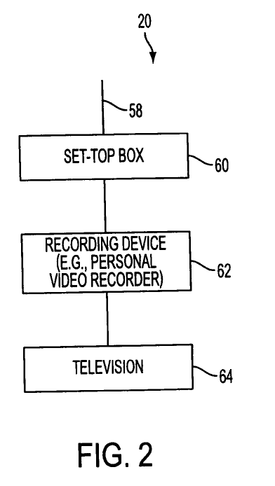

Illustrative user television equipment 20 that is based on a set-top box arrangement is shown in FIG. 2. Input/output 58 may be connected to communications paths such as paths 27 and 46. Input/output functions may be provided by one or more wires or communications paths, but are shown as a single path in FIG. 2 to avoid overcomplicating the drawing. Television programming and other information may be received using input/output 58. Commands and requests and other information from the user may also be transmitted over input/output 58.

Set-top box 60 may be any suitable analog or digital set-top box (e.g., a cable set-top box). Set-top box 60 may contain an analog tuner for tuning to a desired analog television channel. Set-top box 60 may also contain digital decoding circuitry for receiving digital television and music channels. Both analog and digital channels may be handled together if desired. Multiple tuners may be provided (e.g., to handle simultaneous watch and record functions). Set-top box 60 may be an integrated receiver decoder (IRD) that handles satellite television. If desired, set-top box 60 may have circuitry for handling cable, over-the-air broadcast, and satellite content. Set-top box 60 may include a storage device (e.g., a digital storage device such as a hard disk drive) for providing recording capabilities. Set-top box 60 may also be connected to a recording device 62 such as a video cassette recorder, personal video recorder, or other device or devices with storage capabilities.

Set-top box 60 contains a processor (e.g., a microcontroller or microprocessor or the like) that is used to execute software applications. Set-top box 60 may contain memory such as random-access memory for use when executing applications. Nonvolatile memory may also be used (e.g., to launch a boot-up routine and other instructions). Hard disk storage in set-top box 60 or in recording device 62 may be used to back up data and to otherwise support larger databases and storage requirements than may be supported using random-access memory approaches.

Set-top box 60 may have infrared (IR) or other communications circuitry for communicating with a remote control or wireless keyboard. Set-top box 60 may also have dedicated buttons and a front-panel display. The front-panel display may, for example, be used to display the current channel to which the set-top box is tuned.

Set-top box 60 may also have communications circuitry such as a cable modem, an integrated services digital network (ISDN) modem, a digital subscriber line (DSL) modem, a telephone modem, a wireless modem, etc. for communications with other equipment. Such communications may involve the Internet or any other suitable communications networks or paths. If desired, the components of set-top box 60 may be integrated into other user equipment (e.g., a television or videocassette recorder).

Recording device 62 may be used to record videos provided by set-top box 60. For example, if set-top box 60 is tuned to a given television channel, the video signal for that television channel may be passed to recording device 62 for recording on a videocassette, compact disc, digital video disk, or internal hard drive or other storage device. Recording device 62 may have communications circuitry such as a cable modem, an ISDN modem, a DSL modem, a telephone modem, etc. for communications with other equipment. Such communications may involve the Internet or any other suitable communications networks or paths. The components of recording device 62 may be integrated into other user equipment (e.g., a television, stereo equipment, etc.).

Recording device 62 may be controlled using a remote control or other suitable user interface. If desired, video recorder functions such as start, stop, record, etc. and other functions for device 62 may be controlled by set-top box 60. For example, set-top box 60 may control recording device 62 using infrared commands directed toward the remote control inputs of recording device 62 or set-top box 60 may control recording device 62 using other wired or wireless communications paths between box 60 and device 62.

The output of recording device 62 may be provided to television 64 for display to the user. If desired, multiple recording devices 62 or no recording device 62 may be used. If recording device 62 is not present or is not being actively used, the video signals from set-top box 60 may be provided directly to television 64. Any suitable television or monitor may be used to display the video. In the equipment of FIG. 2 and the other equipment of system 10, the audio associated with various video items is typically distributed with those video items and is generally played back to the user as the videos are played.

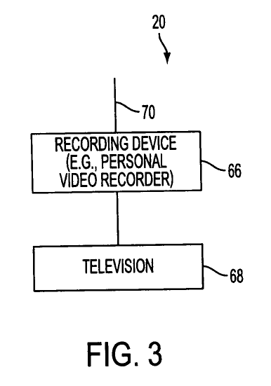

Another illustrative arrangement for user television equipment 20 is shown in FIG. 3. In the example of FIG. 3, user television equipment 20 includes a recording device 66 such as a digital video recorder (e.g., a personal video recorder (PVR)) that uses a hard disk or other storage for recording video or may be a digital video disc recorder, compact disc recorder, videocassette recorder, or other suitable recording device. Equipment 20 of FIG. 3 may-also include a television 68. Input/output 70 may be connected to communications paths such as paths 27 and 46. Television programming and other information may be received using input/output 70. Commands and requests and other information from the user may be transmitted over input/output 70.

Recording device 66 may contain at least one analog tuner for tuning to a desired analog television channel. Recording device 66 may also contain digital decoding circuitry for receiving digital television and music channels. If desired, recording device 66 may contain circuitry for handling both analog and digital channels. Recording device 66 also contains a processor (e.g., multiple tuners may be provided, a microcontroller or microprocessor or the like) that is used to execute software applications. Recording device 66 may contain memory such as random-access memory for use when executing applications. Nonvolatile memory may also be used to store a boot-up routine or other instructions. The hard disk and other storage in recording device 66 may be used to support databases (e.g., program guide databases or interactive television application databases). The hard disk or other storage in recording device 66 may also be used to record video such as television programs or video-on-demand content or other content provided to recording device 66 over input/output 70.

Recording device 66 may have IR communications circuitry or other suitable communications circuitry for communicating with a remote control. Recording device 66 may also have dedicated buttons and a front-panel display. The front-panel display may, for example, be used to display the current channel to which the recording device is tuned.

Recording device 66 may also have communications circuitry such as a cable modem, an ISDN modem, a DSL modem, a telephone modem, a wireless modem, etc. for communications with other equipment. Such communications may involve the Internet or other suitable communications networks or paths.

If desired, recording device 66 may include a satellite receiver or other equipment that has wireless communications circuitry for receiving satellite signals.

Recording device 66 of FIG. 3 or recording device 62 of FIG. 2 may record new video while previously recorded video is being played back on television 68 or 64. This allows users to press a pause button during normal television viewing. When the pause button is pressed, the current television program is stored on the hard disk of digital video recorder 66. When the user presses play, the recorded video may be played back. This arrangement allows the user to seamlessly pause and resume television viewing. Recording device 66 and 62 may also be used to allow a user to watch a previously-recorded program while simultaneously recording a new program.

The set-top box arrangement of FIG. 2 and the digital video recorder set-top box arrangement of FIG. 3 are merely illustrative. Other arrangements may be used if desired. For example, user television equipment may be based on a WebTV box, a personal computer television (PC/TV), or any other suitable television equipment arrangement. If desired, the functions of components such as set-top box 60, digital video recorder 66, a WebTV box, or PC/TV or the like may be integrated into a television or personal computer or other suitable device.

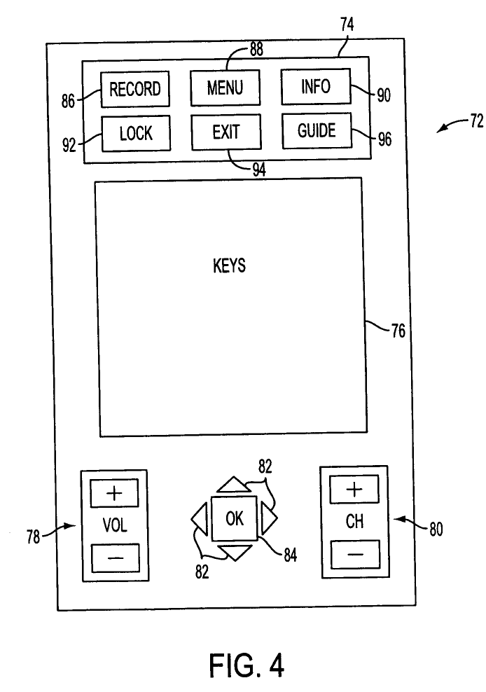

An illustrative remote control 72 for operating user television equipment 20 (or suitable user computer equipment 22) is shown in FIG. 4. Remote control 72 may have function keys 74 and other keys 76 such as keypad keys, power on/off keys, pause, stop, fast-forward and reverse keys, etc. Volume up and down keys 78 may be used for adjusting the volume of the audio portion of a video. Channel up and down keys 80 may be used to change television channels and to access content on virtual channels. Cursor keys 82 may be used to navigate on-screen menus. For example, cursor keys 82 may be used to position an on-screen cursor, indicator, or highlight (sometimes all generically referred to herein as a highlight or highlight region) to indicate interest in a particular option or other item on a screen displayed by the interactive television application.

An OK key 84 (sometimes called a select or enter key) may be used to select on-screen options that the user has highlighted.

Keys 74 may include a record key 86 for initiating recordings. Menu button 88 may be used to direct the interactive television application to display a menu on the user's display screen (e.g., on television 64 or 68 or on a suitable monitor or computer display). Info button 90 may be used to direct the interactive television application to display an information display screen. If the user has highlighted a particular program listing, for example, pressing the info button 90 may direct the interactive television application to provide additional program schedule information related to that program listing (e.g., a program summary, actor information, etc.).

Lock button 92 may be used to modify access privileges. For example, a parent may use lock button 92 or on-screen options to establish parental control settings for the interactive television application. The parental control settings may be time-based settings (e.g., to prevent a child from watching television during a particular time block such as from 3:00 PM to 5:00 PM). The parental control settings may also be used to block programming based on rating, channel, program title, etc. A locked or blocked program is typically not viewable until the interactive television application is provided with a suitable personal identification number (PIN). Once this PIN has been entered, the interactive television program will unlock the user's equipment and allow the locked content to be accessed.

Exit button 94 may be used to exit the interactive television application or to exit a portion of the interactive television application. Guide button 96 may be used to invoke the interactive television program guide.

The keys shown in FIG. 4 are merely illustrative. Other keys or buttons may be provided if desired. For example, a music button may be used to access music with the interactive television application. An edit button may be used to edit stored content (e.g., to remove commercials, remove portions of a video, etc.). Alphanumeric buttons may be used to enter alphanumeric characters. A last or back button may be used to browse backward in the interactive television application (e.g., to return to a previous channel or display screen). Video recorder function buttons such as a play button, pause button, stop button, rewind button, fast-forward button, and record button, may be used to control video recorder functions (local or network-based) in system 10. A help key may be used to invoke help functions such as context-sensitive on-screen help, etc.

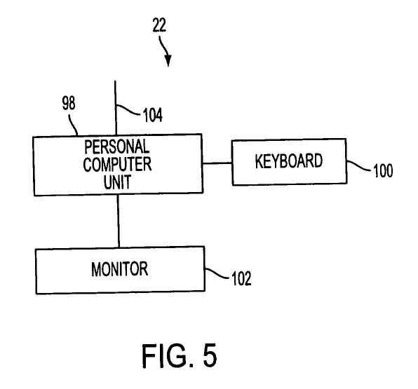

Illustrative user computer equipment 22 is shown in FIG. 5. In the arrangement of FIG. 5, personal computer unit 98 may be controlled by the user using keyboard 100 or other suitable user input device, such as a trackball, mouse, touch pad, touch screen, voice recognition system, a remote control such as remote control 72 of FIG. 4, etc. Video content such as television programming and interactive television application display screens may be displayed on monitor 102. Television programming, video-on-demand content, video recordings played back from a network-based video recorder, and other information may be received from paths 28 and 48 (FIG. 1) using input/output 104. The user may also send commands and other information used during interactions with the interactive television application and system 10 over input/output line 104.

Personal computer unit 98 may contain a television or video card such as television tuner card for decoding analog and digital television channels and for handling streaming video content. Multiple video cards (e.g., tuner cards) may be provided if desired. An illustrative television tuner card that may be used may contain an analog television tuner for tuning to a given analog channel and digital decoding circuitry for filtering out a desired digital television or music channel from a packetized digital data stream. Any suitable card or components in computer unit 98 may be used to handle video and other content delivered via input/output line 104 if desired.

Personal computer unit 98 may contain one or more processors (e.g., microprocessors) that are used to run the interactive television application or a portion of the interactive television application.

Storage in personal computer unit 98 such as a hard drive, DVD drive, CD drive, or other suitable storage device or devices may be used to store video and other content. For example, the interactive television application and personal computer unit 98 may use this storage to provide the functions of a personal video recorder.

User equipment 18 such as user television equipment 20 and user computer equipment 22 may be used with network equipment such as server 56, server 36, and equipment at service providers such as service provider 50 of FIG. 1 to provide network-based video recording functions. Video recording functions may be provided by storing copies of television programs and other video content on a remote server (e.g., server 56 or server 36 of FIG. 1) or other network-based equipment such as equipment at a service provider such as service provider 50.

Video recordings may be made in response to user commands that are entered at user equipment 18. In a personal video recorder arrangement, the interactive television application may be used to record video locally on the user equipment in response to the user commands. In a network-based video. recorder arrangement, the interactive television application may be used to record video or to make virtual recordings on network equipment such as server 36, 56, or equipment at service provider 50 in response to the user commands. The user commands may be provided to the network equipment over the communications paths shown in FIG. 1. The personal video recorder arrangement and the network-based video recorder arrangement can support functions such as fast-forward, rewind, pause, play, and record.

To avoid unnecessary duplication in a network-based video recorder environment, the system 10 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area.

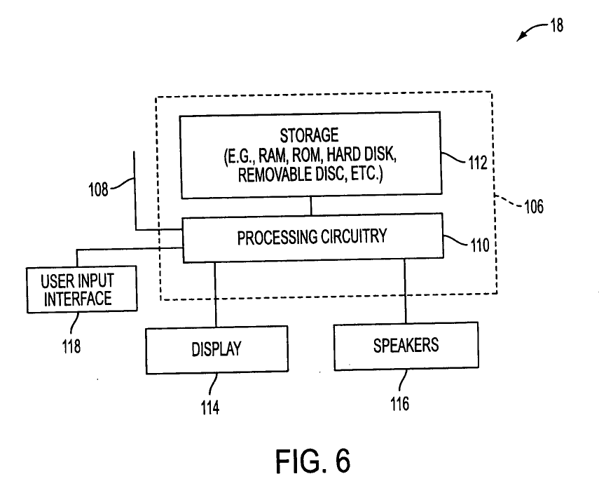

The user television equipment and user computer equipment arrangements described above are merely illustrative. A more generalized embodiment of illustrative user equipment is shown in FIG. 6.

As shown in FIG. 6, control circuitry 106 is connected to input/output 108. Input/output 108 may be connected to one or more communications paths such as paths 26, 27, 28, 42, 46, and 48 of FIG. 1. Television and music programming may be received via input/output 108 (e.g., from programming sources 12, servers or other equipment such as server 36, service providers such as service provider 50, and television distribution facility 14). Program schedule information for an interactive television program guide may be received from data source 30 via input/output 108. Input/output 108 may also be used to receive information from data source 30 for other interactive television applications. The user may use control circuitry 106 to send commands, requests, and other suitable information using input/output 108.

Control circuitry 106 may be based on any suitable processing circuitry 110 such as processing circuitry based on one or more microprocessors, microcontrollers, digital signal processors, programmable logic devices, etc. Memory (e.g., random-access memory and read-only memory), hard drives, DVD drives, CD drives, or any other suitable memory or storage devices may be provided as storage 112 that is part of control circuitry 106. Tuning circuitry such as one or more analog tuners, one or more MPEG-2 decoders or other digital video circuitry, or any other suitable tuning or video circuits or combinations of such circuits may also be included as part of circuitry 106. Encoding circuitry (e.g., for converting over-the-air or cable analog signals to MPEG signals for storage) may also be provided. The tuning and encoding circuitry may be used by the user equipment to receive and display or play or record a particular television or music channel or other desired audio and video content (e.g., video-on-demand content or requested network-based or local video recorder playback). Television programming and other video and on-screen options and information may be displayed on display 114. Display 114 may be a monitor, a television, or any other suitable equipment for displaying visual images. Speakers 116 may be provided as part of a television or may be stand-alone units. Digital music and the audio component of videos displayed on display 114 may be played through speakers 116.

A user may control the control circuitry 106 using user input interface 118. The user input interface 118 may be any suitable user interface, such as a mouse, trackball, keypad, keyboard, touch screen, touch pad, voice recognition interface, remote control, etc.

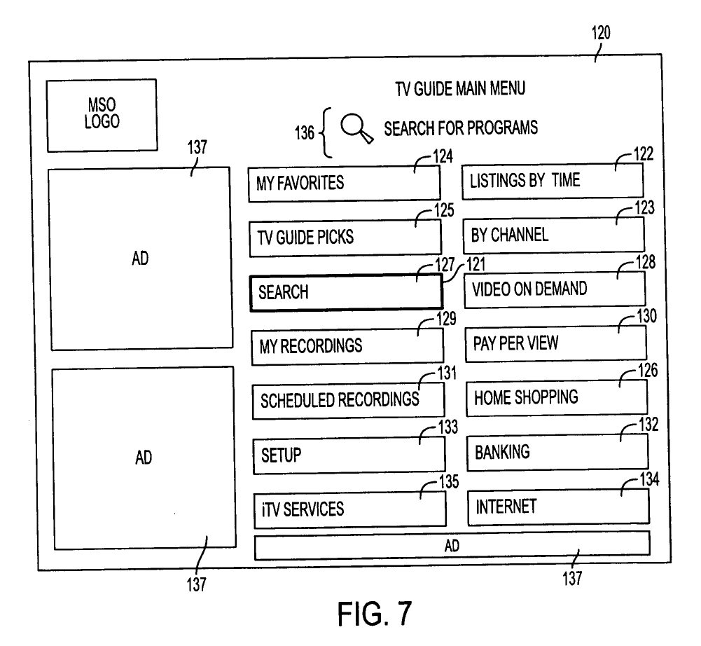

An illustrative menu 120 that may be displayed on the user's display screen is shown in FIG. 7. As shown in FIG. 7, menu 120 may provide the user with an number of selectable options. The options shown in FIG. 7 are merely illustrative. Any suitable options may be provided if desired.

A user of user equipment 18 (e.g., a user of user television equipment 20 or a user of user computer equipment 22, or a user of any other suitable user equipment device) may invoke an interactive television menu such as menu screen 120 by pressing menu button 88 (FIG. 4). Remote control 72 (FIG. 4) or other user interface 118 (FIG. 6) may be used to position highlight region 121 on top of selectable options such as options 122-135. If the user selects option 122 or 123, a screen of program listings may be displayed. Option 124 may be used to display program listings for channels designated by the user as “favorites.” Option 125 may be used to provide program listings selected for promotion by a service provider (e.g., a program guide service provider, a cable operator, etc.). Option 126 may be used to invoke a home shopping service. Options 127 may be used to search program listings by title, time, category, or any other criteria. Option 128 may be selected to display options related to video-on-demand services. Option 129 may be selected to display an interactive list of previously recorded recordings and option 131 may be selected to display an interactive list of programs scheduled for recording. Option 130 may be selected to display pay-per-view program listings and pay-per-view services options. If the user selects option 132, the user may be presented with an opportunity to access home banking functions. Option 133 may be selected to change system setup options and option 134 may be selected to launch a web browser or other application for accessing the Internet. Option 135 may be selected to access other interactive television services. When the user selects an option with highlight region 121 from menu screen 120, the user's selection may be described in information display region 136.

If desired, program guide screens such as menu screen 120 and other interactive television application screens may include selectable advertisements 137. Any suitable advertisements may be provided, including panel advertisements, banner advertisements, advertisements provided between program listings, advertisements provided on certain program listings or other portions of the screen, or any other suitable advertisements. A user may use cursor keys 82 of remote control 72 (FIG. 4) to position a highlight region on an advertisement of interest and may select the highlighted advertisement using OK key 84. Users of other user interfaces may make appropriate selections using the buttons or controls available through those interfaces (e.g., using voice commands if the user interface involves a voice recognition arrangement, etc.).

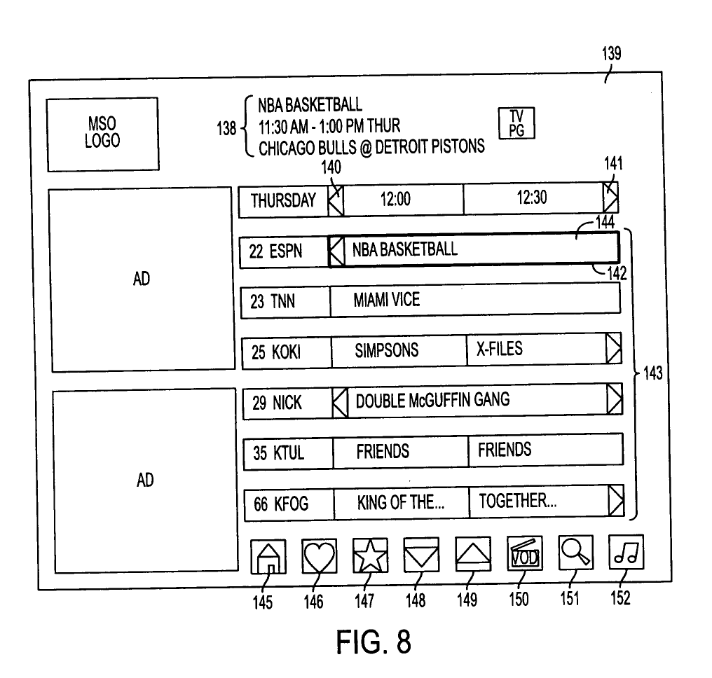

An illustrative program guide screen 138 that may be displayed for the user is shown in FIG. 8. Program guide screen 138 may be displayed, for example, when the user selects program listings option 122 of FIG. 7, when the user selects a suitable option from within an interactive television program guide application or other interactive television application, or when the user presses an appropriate remote control button such as guide button 96 or otherwise uses user input interface 118 to indicate a desire to view program listings.

Program guide screen 138 may contain a grid or list of program listings 143. Program listings 143 may include program titles, channels, scheduled broadcast times, and any other suitable program schedule information. Highlight region 142 may be used to select a desired program listing 144. Program Information for selected programs may appear elsewhere on program guide screen 138 (e.g., in program information display region 139). If the user presses OK key 84 when a program listing for a current program is highlighted, the interactive television application may tune to the channel for that program. If the user presses OK key 84 when a program listing for a future program is highlighted, the interactive television application may provide the user with an opportunity to set a reminder for that program or to record that program.

Other functions that the interactive television application may provide include the ability to set favorites or establish preferences or other settings. For example, the user may select a particular channel for the program guide to automatically tune to when the user equipment is turned on. The user may also select favorite programs, favorite channels, etc. The program guide or other interactive television application may provide the user with the ability to establish parental control settings, the ability to search for programming of interest, and the ability to view program descriptions, advertisements, text, graphics, and video, etc. These are merely illustrative examples of interactive television functions that may be provided by interactive television system 10. Other suitable interactive television functions may be provided if desired.

A user may access program listings (e.g., program listings of the type shown in FIG. 8) by using the interactive television application to select an on-screen option such as option 122 and 123 of FIG. 7, by pressing a dedicated guide button such as guide button 96 on remote control 72, by selecting any other suitable button or on-screen option, etc. In the example of FIG. 8, program listings are currently being displayed for television programs that air between 12:00 noon and 1:00 PM. As shown by arrows 140 and 141, the user may use right or left cursor keys to navigate to other times (e.g., to direct the interactive television application to display appropriate screens of program listings 143 for different time periods). If desired, the user may select options or press keys (or use user input interface 118 to otherwise enter suitable commands) that direct the interactive television application to display program listings organized by channel, by genre, by service type (e.g., pay-per-view or regular broadcast television), etc.

Selectable options, such as options 145, 146, 147, 148, 149, 150, 151, and 152, may be provided as part of program guide screen 138 or any other program guide screen for providing access to various interactive television application features. For example, option 145 may be used to display a home screen or main menu, such as menu screen 120 of FIG. 7. Option 146 may be selected to display program listings for channels designated by the user as “favorites.” Option 147 may be selected to display listings of recommended programs using highlight region 142. Scroll indicators 148 and 149 may be used to navigate down and up through program listings. Option 150 may be selected to display information related to video-on-demand services. Option 151 may be selected to search television program listings by title, time, category, or any other suitable criteria. Option 152 may be selected to display information related to digital music services.

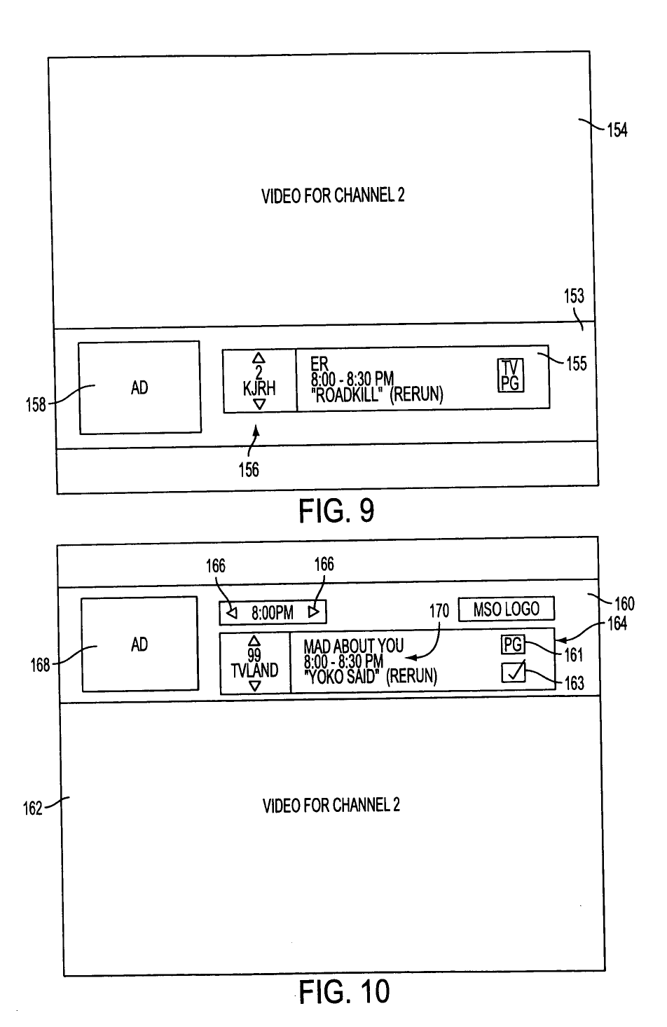

The interactive television application may provide a “flip” tuning feature. As shown in FIG. 9, when the user invokes the flip mode, flip display 153 may be provided over a portion of a channel (i.e., channel 2) that the user is currently tuned to and is watching on display screen 154. Flip display 153 contains information (in region 156) on the program 155 appearing on the current channel (channel 2) to which the set-top box 60 or other user equipment is tuned. The user may change the channel using channel up and down keys on the remote control or using user interface 118 to issue other suitable channel change commands. This simultaneously changes the channel to which the set-top box 60 or other user equipment is tuned and the channel information displayed in region 156 (and the associated program information 155).

The flip display 153 may be removed manually or automatically (e.g., after a few seconds or other suitable time period of user inactivity). When the user starts changing channels again, the flip display 153 may be displayed again.

The flip feature of the interactive television application therefore allows the user to view program information for the channel that the user is currently viewing as the user changes channels. In the example of FIG. 9, the flip display 153 is displayed in the form of an overlay on top of the current channel. If desired, the video for the current channel may be reduced in size and the flip information (e.g., the program title and channel information for the current program) may be displayed at a location on the periphery of the reduced-size video (e.g., at the bottom, side, or top of the reduced-size video).

An advertisement 158 or other content may be provided in the flip display region if desired. Other optional information that may be displayed in flip display 153 includes information on the scheduled broadcast times for the program 155, ratings information, program descriptions, and other program-related information.

The interactive television application may also be used to provide a browse feature. As shown in FIG. 10, when the user invokes the browse feature (e.g., by pressing an up or down cursor key), browse display 160 may be displayed as an overlay over a portion of the channel (i.e., channel 2) that is being displayed on the user's display screen 162 and to which the user is currently tuned. Browse display 160 may initially contain information on the current channel. For example, browse display 160 may, when initially invoked by the user, contain the title of the current program and information on the current channel such as the current channel number, call letters, and network logo.

When the user presses the up or down cursor key (or enters other suitable commands using user interface 118), the browse display may be changed to display information on the programming available on other channels. In the example of FIG. 10, the user has pressed the cursor keys repeatedly, until the user has browsed to channel 99. The video that is being displayed on display screen 162 has not changed in this example (channel 2 is still being displayed).

As indicated by arrows 166, the user may use right and left cursor keys 82 (or other suitable controls) to browse to other time slots (e.g., to view information related to programming that is scheduled for broadcast at a later time). Browse display 160 may contain an advertisement 168, information 170 on scheduled program times, program descriptions and other program-related information and icons such as check icon 163 (to indicate that a reminder has been set for a given program) and ratings icon 161.

If the user locates a currently available program of interest on another channel, the user may press the OK key 84 to direct the interactive television application to tune the user equipment to that channel.

The browse display 160 may be removed manually or may be removed automatically from display screen 162 after a suitable period of user inactivity (e.g., after a few seconds or a minute or two).

If desired, the browse display can be displayed on the periphery of the video for the current program rather than as an overlay. The video for the current channel may be reduced in size accordingly.

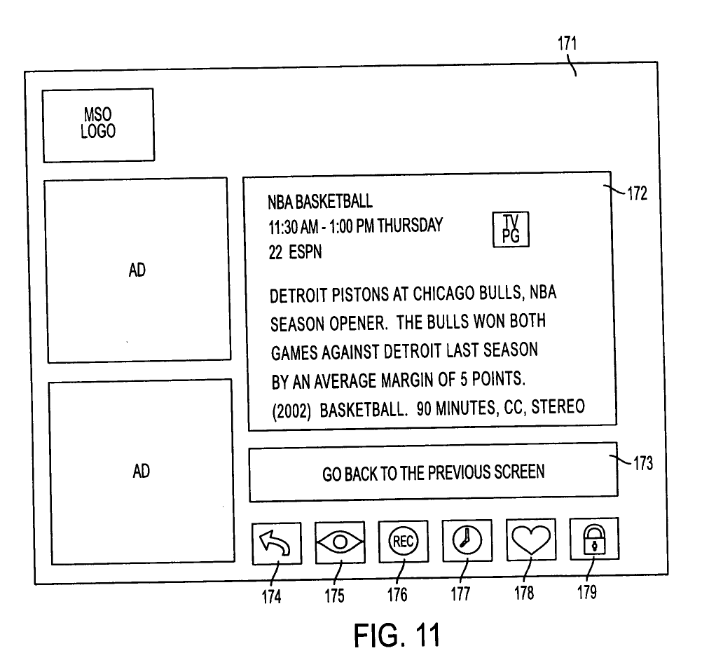

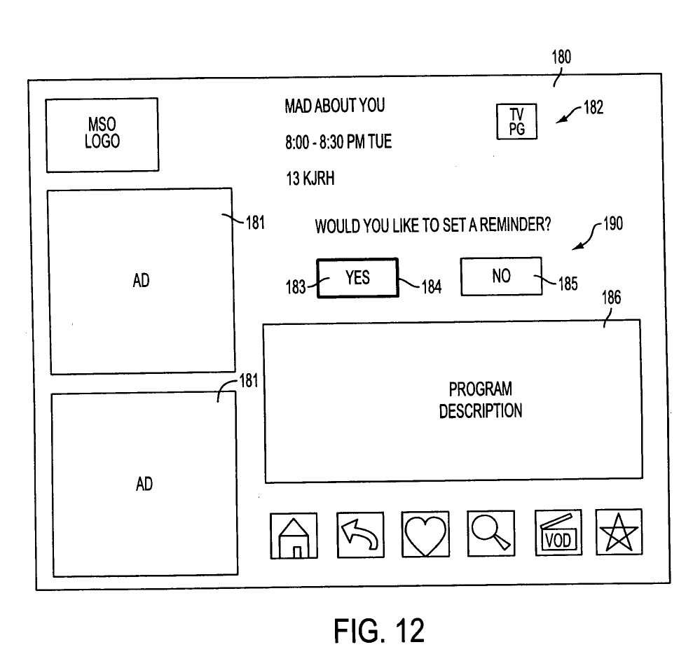

When the user has indicated interest in a program (e.g., by positioning highlight region 142 of FIG. 8 on top of a given program listing, by tuning to a program, by viewing a program listing on the flip banner of FIG. 9 or the browse banner of FIG. 10, etc.), the user may press info key 90 (FIG. 4) to obtain more information for that program. Illustrative info screens 171 and 180 that may be displayed when a user presses info button 90 are shown in FIGS. 11 and 12, respectively. Screens such as screens 171 and 180 may be provided when a user selects a program listing from a interactive television application screen (e.g., program guide screen 138 of FIG. 8). Info screen 171 of FIG. 11 may include a detailed description 172 of a program selected by the user. Description 172 may include, for example, the title, time, channel, and rating of the program, or any other suitable information. As in FIG. 8, selectable options may be provided as part of info screen 171 to provide access to various interactive television application features. For example, option 174 may be used to return to the previous program guide screen. Option 175 may be used to tune to the selected program or set a reminder for the selected program (e.g., the program for which information is displaying in description 172). Option 176 may be selected to display recording options and services for the selected program. Option 177 may be selected to display options for adding a reminder for the selected program. Option 178 may be used to display options for adding the selected program or channel to a user's favorites, and option 179 may be used to display options for providing a parental lock on the selected program. Selectable options for other interactive television application features may also be provided. A highlight region may be used to select any of the selectable options provided by a program guide screen information describing a highlighted option may be provided, for example, in information display region 173.

Information screens may include advertisements. For example, info screen 180 of FIG. 12 may include selectable advertisements 181. Information regions on screen 180 such as title region 182 and program description region 186 may be used to display information on the selected program such as title information, ratings information, plot summary information, information about actors, genre, critics ratings, etc.

Region 190 may be used to inform the user of the possibility of setting a reminder for the selected program, of tuning to the channel showing the selected program, of recording the selected program, of purchasing the selected program if it is a pay-per-view program, of parentally controlling the selected program, of configuring a related profile or preference settings, or performing any other suitable action related to the selected program. Region 190 may also be used to provide additional information related to the selected program. The user may position highlight region 184 on top of either yes option 183 or no option 185 or any other suitable options (e.g., options to tune to the channel, to record the program, to purchase the program, to parentally control the program, to configure the preference settings, etc.). When the user presses the OK key 84, the interactive television application may then take appropriate actions. If the user opts to set a reminder for the program listed in the info screen 180, the interactive television application may display a pop-up reminder overlay on top of the video for the channel that the user is currently watching just before the program associated with the reminder is scheduled to begin, or any suitable display screen that is active at the time that the reminder pops up (e.g., a program listings screen).

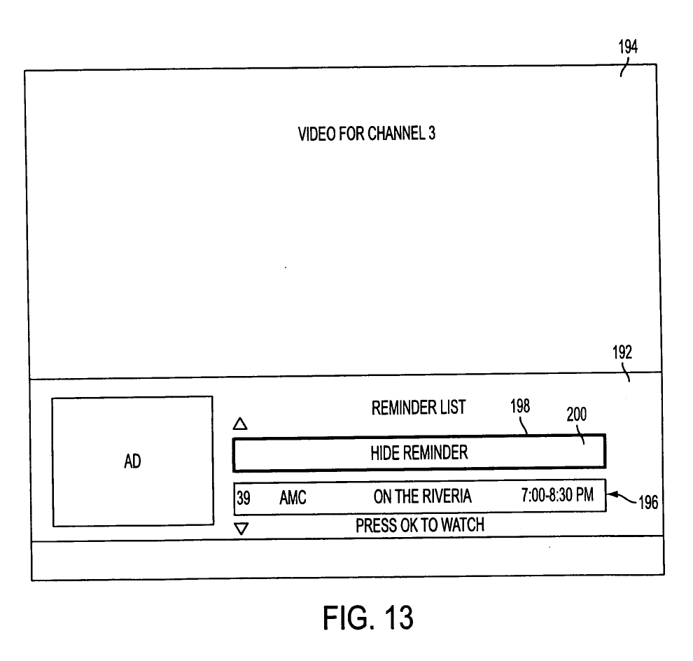

An illustrative reminder is shown in FIG. 13. In the example of FIG. 13, the user is watching channel 3. The current time is 6:58 PM. Previously, the user set a reminder for the program “On The Riviera,” which is scheduled to be shown on channel 39 at 7:00 PM. Because the program for which the user set the reminder is just about to begin, the interactive television application displays reminder list 192 as an overlay on top of the video for channel 3 that is being presented on display screen 194. The reminder list may contain a list of one or more programs for which the user has set reminders. In the example of FIG. 13, one program listing 196 (“On The Riviera”) is displayed.

The user can tune to a program by selecting that program from the reminder list 192. For example, the user may position highlight region 198 on listing 196 and may select that listing by pressing the OK key 84. The interactive television application may then tune the user to the channel for the desired program (i.e., channel 39 in this example).

The user can close the reminder list by pressing the OK key 84 while hide reminder option 200 is highlighted.

The reminder list may be displayed at any suitable time (e.g., at 0-15 minutes before the program of interest is to begin, at a user-selected time before that program, etc.). Moreover, the reminder list may be displayed around the periphery of the video for the current channel and the video for the current channel may be displayed in a reduced-size window. These are merely illustrative examples. Any suitable arrangement may be used to notify the user of upcoming programs or in-progress programs for which the user has set reminders and other programs of interest.

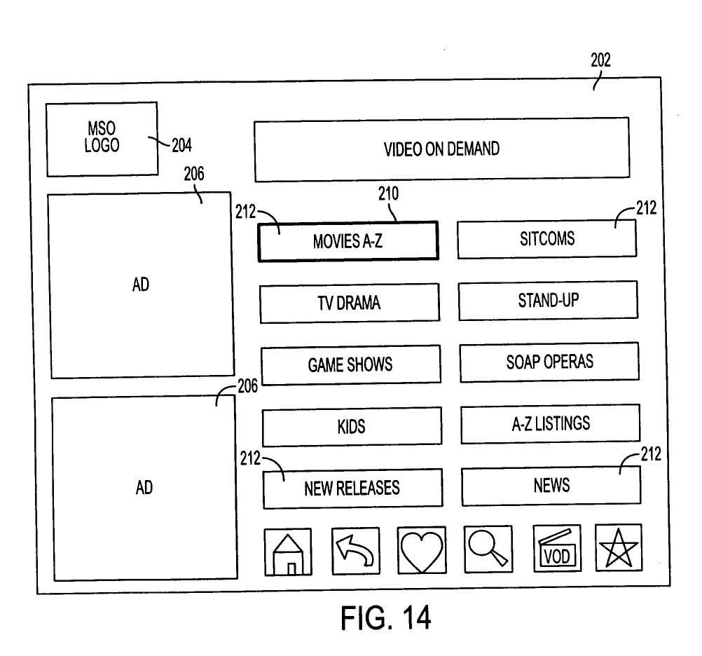

The interactive television application may be used to provide the user with access to video-on-demand content. The user may, for example, be provided with an option such as video-on-demand option 128 on menu screen 120 of FIG. 7. When the user selects option 128, the interactive television application may display a screen such as video-on-demand categories screen 202 of FIG. 14. Screen 202 may include logos such as logo 204, selectable (or non-selectable) advertisements such as advertisements 206, and a screen title 208. The user may position highlight region 210 on an option 212 corresponding to a video-on-demand category of interest.

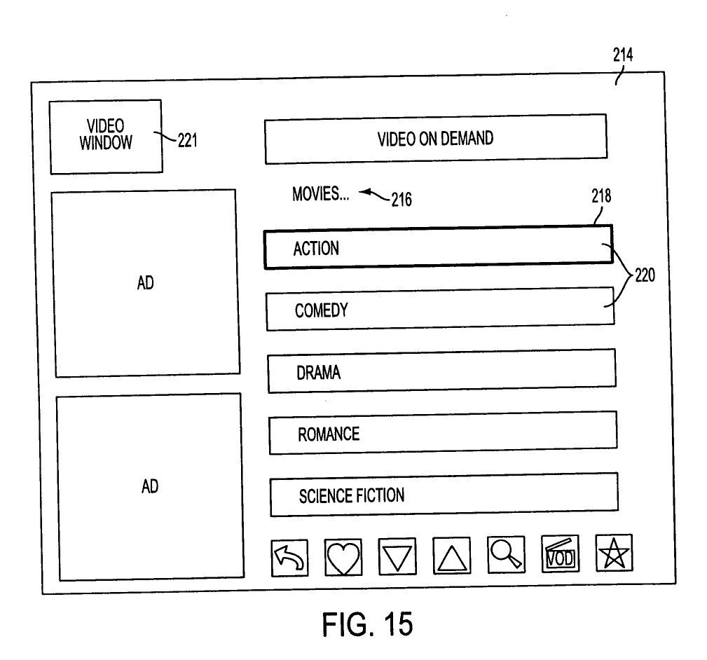

When the user selects the video-on-demand category of interest from screen 202, the interactive television application may display a display screen such as subcategory selection screen 214 of FIG. 15. In the example of FIG. 15, the subcategories screen 214 contains subcategory options 220 corresponding to movies, because (in this example) the user selected movies A-Z option 212 from screen 202 in FIG. 14. Video window 221 may be provided in any video-on-demand information screen and may provide information relating to a video-on-demand program selected by the user or any other suitable video information.

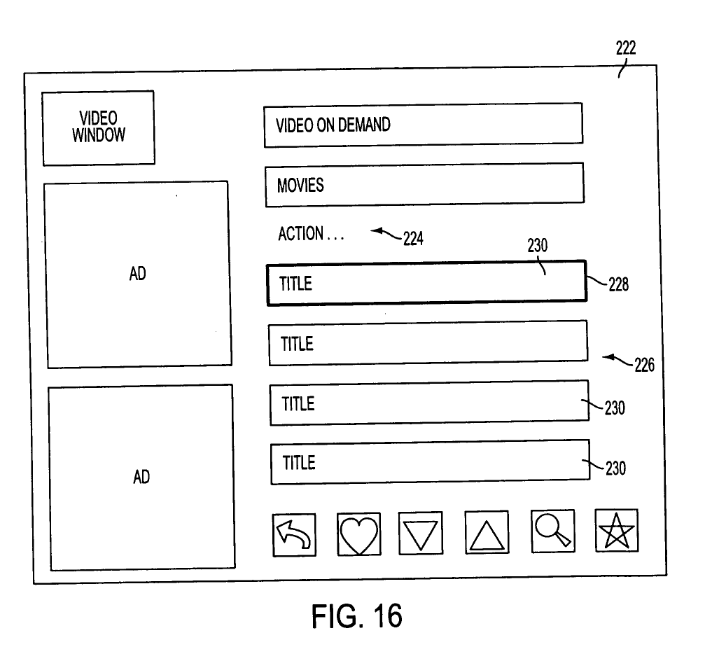

The user may position highlight region 218 onto a desired subcategory 220 and may press OK key 84 to view a list of available video-on-demand content associated with that subcategory. An illustrative display screen 222 that the interactive television application may display for the user when the action subcategory option 220 (FIG. 15) is selected is shown in FIG. 16. As shown in FIG. 16, display screen 222 may include information identifying the selected subcategory 224. Screen 222 may also include a list 226 of titles 230 (or other content indicators). The user may position highlight region 228 on a desired video-on-demand title 230 and may press the OK key to proceed with the selection of that title.

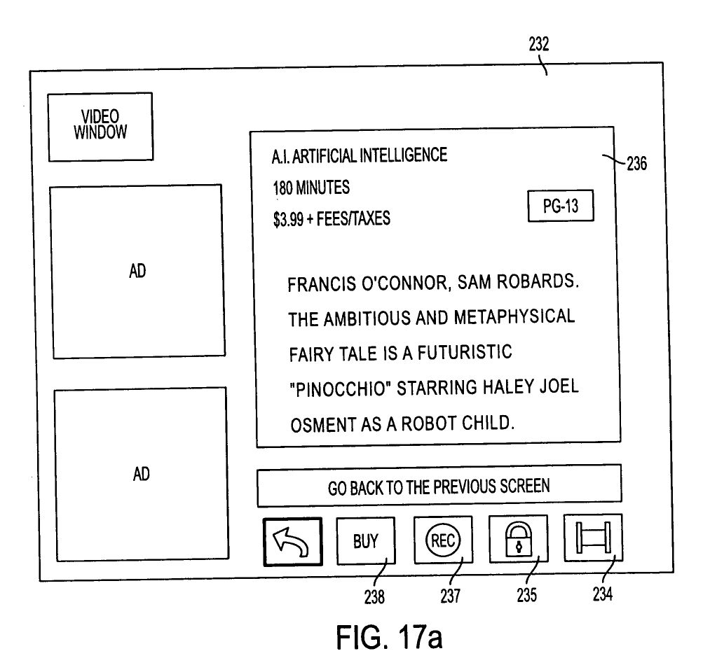

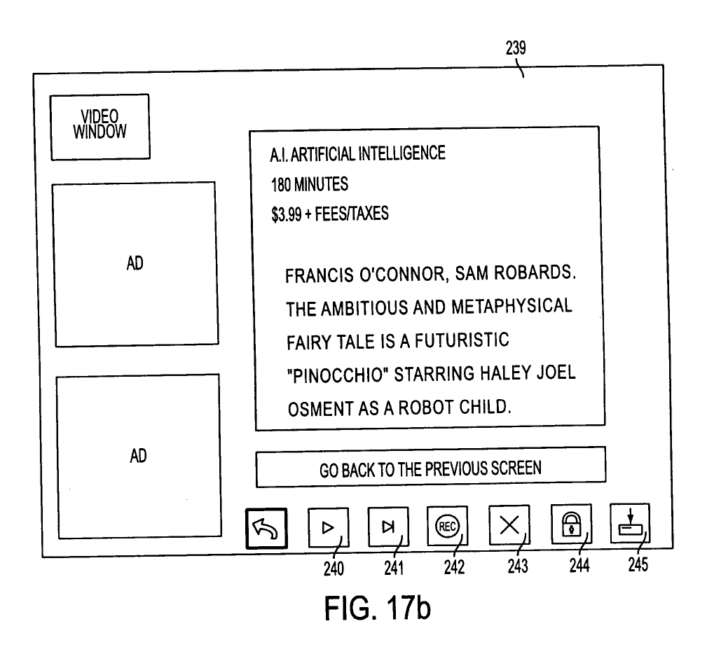

Selecting a desired video-on-demand title 230 from title selection screen 222 may direct the interactive television application to display a video-on-demand information screen such as information screen 232 of FIG. 17a. Screen 232 may include information 236 on the selected video-on-demand content, such as title, run time, price, rating, and a description of the selected video-on-demand content.

Selectable options, such as options 234, 235, 237, and 238 may be provided as part of screen 232 to provide access to various interactive television application features. For example, option 238 may be selected to access options for ordering the selected video-on-demand content. Option 237 may be used to access options for recording the selected content, and option 235 may be used to access options for setting parental control locks for the selected content. If the user selects option 234, the interactive television application may display a video clip containing information on the video-on-demand content of interest (e.g., a promotional video such as a preview, a trailer, a review, etc.). The video clip may be delivered to the user equipment 18 from a server such as server 36 or server 56 of FIG. 1 or from equipment at a service provider such a service provider 50. The interactive television application .may also provide the user with additional information on the video-on-demand content in response to the user selecting option 234. Other suitable selectable options may also be provided on screen 232 (e.g., a program package information and purchase option, options for searching program listings for related content, etc.).

If a user requests information for video-on-demand content that has already been ordered, the interactive television application may provide video-on-demand information screen such as screen 239 of FIG. 17b, which may include selectable options different than those provided for screen 232 of FIG. 17a. For example, option 240 may be used to start playing selected video-on-demand content from the program position most recently viewed. Option 241 may be used to present the selected content from the beginning, and option 242 may be used to access options for recording the content. Option 243 may be used to remove the selected content from a listing of the ordered and available content. Option 244 may be used to access options for setting parental control locks for the selected content. If the selected content is being accessed over a network or being provided by a network storage device, option 245 may be used to store the content on a local storage device.

In response to a user ordering selected content (e.g., by selecting an on-screen order option such as option 238 of FIG. 17a, or by using remote control 72 or any other suitable input device 118 to order content, etc.), the interactive television application may deliver the ordered video-on-demand content to the user equipment from a server such as server 36 or server 56 or from a service provider such as service provider 50. The communications paths and communications network 34 of FIG. 1 may be used in delivering the requested content.

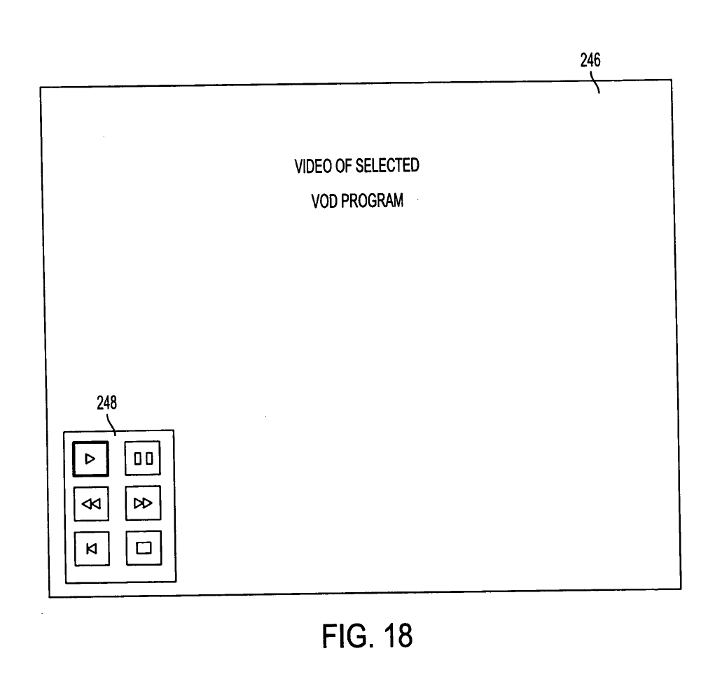

The ordered video-on-demand content may be displayed for the user on a display screen such as video-on-demand playback screen 246 of FIG. 18. As shown in the lower portion of screen 246, interactive options may be displayed in a toolbar 248 or other suitable format. The interactive options 248 (or similar remote control buttons) may allow the user to rewind the video-on-demand content to the beginning, rewind, play, fast-forward, pause, stop delivery of the video-on-demand content, or perform other video playback options. The arrangement of FIG. 18 is merely illustrative. For example, the video-on-demand content may be played back in a reduced size window (of fixed or user-selectable size).

The interactive television system 10 may be used to support video recorder functions. The video recorder functions may be supported using local arrangements (e.g., arrangements in which a personal video recorder or other suitable equipment in the user's home is used to record videos on a local hard drive or other storage device) and network-based arrangements (e.g., arrangements in which network equipment such as servers 36 and 56 or equipment at a service provider such as service provider 50 is used to store video and data for the user). Combinations of these arrangements may also be supported using system 10.

In a local video recorder arrangement (sometimes called a personal video recorder arrangement or local digital video recorder arrangement), video recordings are stored locally on the user equipment. Information on which videos have been recorded may also be maintained locally. Program guide information (e.g., titles, rates, descriptions, categories, etc.) may also be maintained for the recorded videos. When a user desires to view a list of the recordings that the user has stored on the user equipment, the interactive television application may retrieve this information from local storage and may display this information to the user locally on user equipment 18. The user may then select a desired recording to play back.

In a network-based video recorder arrangement (sometimes called a client-server video recorder arrangement), videos may be stored on the network (e.g., at servers such as servers 36 and 56 or at a service provider such as service provider 50). Information on which programs have been recorded for the user may be stored locally and on the network (e.g., at servers such as servers 36 and 56 or at a service provider such as service provider 50).

Network-based recordings may be made in a number of ways. For example, some or all of the regularly-broadcast television programming provided by programming sources 12 may be automatically recorded or copies of this programming otherwise maintained on a suitable network storage device such as server 36, server 56, or equipment at a service provider such as service provider 50. If the user chooses to “record” a program, no actual recording need be made, because a copy of the desired program already exists on the system. With this type of arrangement, virtual recordings take the place of real recordings.

The user may be given a “personal area” on the network. The personal area may be accessed when the user enters an appropriate personal identification number or by virtue of the user's connection to the network through a known or trusted communications path (e.g., when the user is connected through a dedicated cable path to a server at a cable system headend such as a server 56 at television distribution facility 14 of FIG. 1).

The personal area may be used to maintain a list of the video content that the user has recorded. Whenever the user directs the network-based video recorder portion of the interactive television system to make a recording, the system updates the user's personal area to make it appear as though an additional “real” copy of the requested recording has been made. The network-based video recorder implemented with this approach therefore conserves storage space, while providing users with the illusion of access to a network-based video recorder dedicated to their personal use.

Alternatively, there may be no personal area and each user may have access to all previously recorded content to which they had rights when originally broadcast.

As another example, some or all of the content for which a user requests that a recording be made may be recorded by creating actual copies (e.g., digital recordings) of the requested content. These actual copies may be stored on network equipment (e.g., servers such as servers 36 and 56 or equipment at a service provider such as service provider 50).

Programs recorded onto a network server may be copied to a user's local storage.

A combination of these approaches may be used if desired. For example, some content may be automatically retained by the system (e.g., copies of popular programming). The user may make virtual recordings of this material. The presence of the virtual recordings may be reflected in the user's personal area. Other content may be stored in the form of actual recordings at the direction of the user (e.g., less popular content). The presence of these recordings may also be reflected in the user's personal area.

Regardless of the way in which network-based recordings (virtual or real) and local recordings are made, the interactive television application may be used to provide the user with interactive display screens that assist the user in making recordings, managing recordings (e.g., editing recordings, deleting recordings, renaming recordings, sending recordings to other users over the communications paths of FIG. 1, etc.), playing back recordings, viewing information about recorded programs, etc.

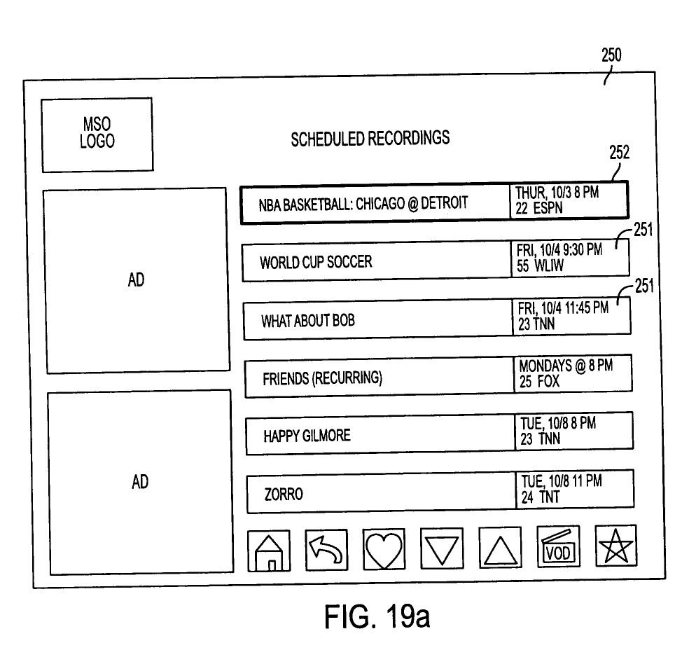

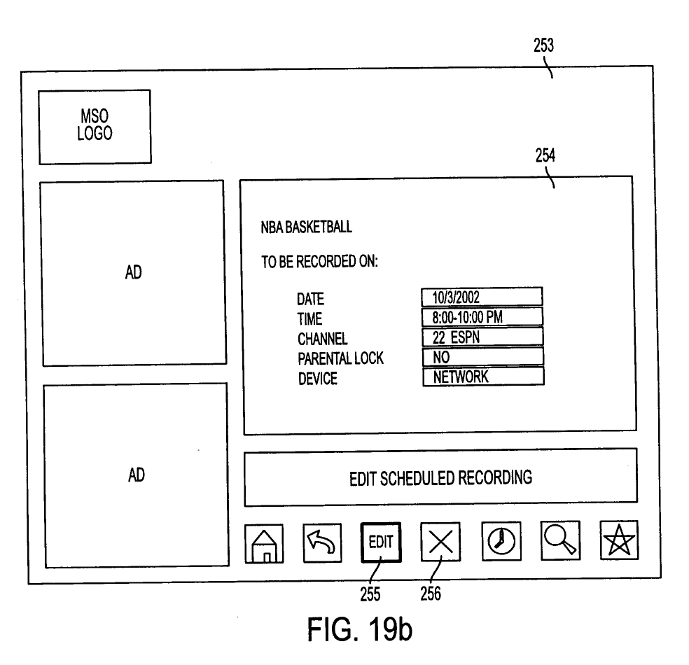

Once a program has been selected by a user for recording, the selected program may be presented in an interactive list of programs scheduled to be recorded. An illustrative scheduled recordings screen 250 that may be displayed for the user on user equipment 18 is shown in FIG. 19a. Screen 250 may be displayed by the interactive television application when the user selects an option provided by another program guide screen, such as program guide screen 120 of FIG. 7 or any other suitable option. Screen 250 may include, for example, a list of programs scheduled to be recorded 251. A highlight region 252 may be used to select a scheduled recording from the list. The user may position highlight region 252 on a desired scheduled recording and select the scheduled recording using an appropriate key of remote control 72.

Information about a scheduled recording selected by the user may be presented in a screen such as screen 253 of FIG. 19b. Screen 253 may include scheduled recording information 254, which may show the date, time, and channel for which a program is to be recorded. Information 254 may also indicate which device has been designated to record the program and whether a parental lock is set for the program scheduled to be recorded. The user may edit information 254 by selecting edit option 255 using a highlight region. Other selectable options may be provided in screen 253, for example cancel option 256 which the user may select to cancel the scheduled recording.

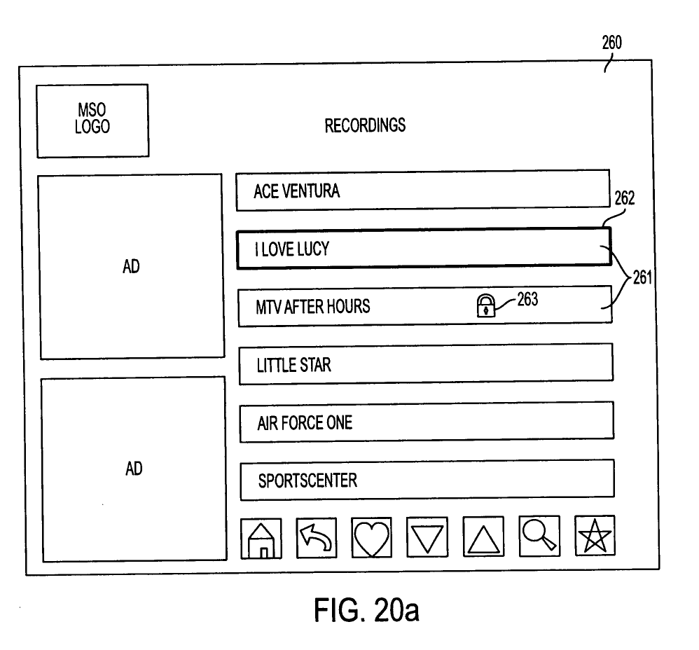

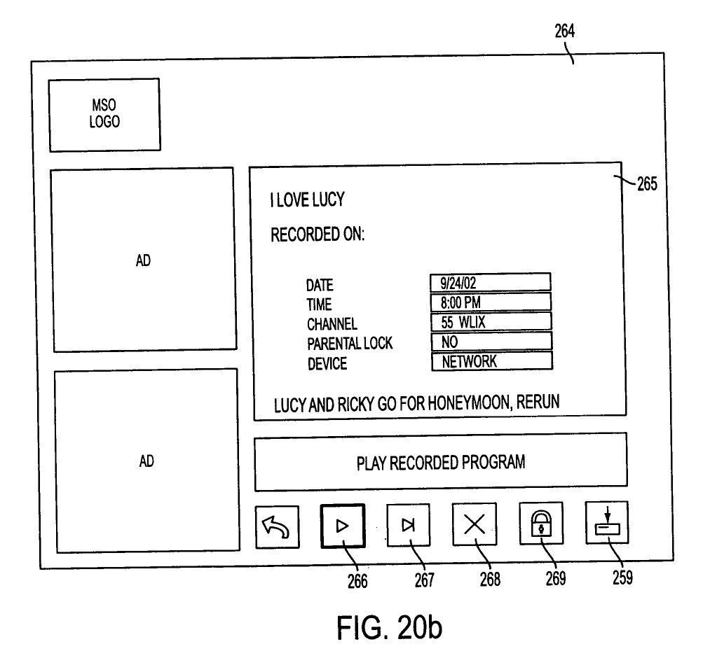

Once a program has been recorded, a program guide screen may be presented to display recorded programs. An illustrative video recordings screen 260 that may be displayed for the user on user equipment 18 is shown in FIG. 20. Screen 260 may be displayed by the interactive television application when the user selects an option provided by another program guide screen, such as program guide screen 120 of FIG. 7 or any other suitable option. The recordings 261 may be local recordings that are stored on the user's equipment 18 or may be real or virtual network-based recordings (e.g., network-based content stored on equipment such as server 36 or server 56 or at service provider 50). In a network-based video recorder environment with a personal area, screens such as screen 260 provide access to all or part of the user's personal area. The user may navigate through the personal area using remote control 72 or other suitable user interface 18.

Screen 260 may include a list of the user's recordings 261. Recording listings may include the time and channel the program was recorded or any other suitable information. The user may position highlight region 262 to select a recording of interest (e.g., to view that recording, to view information about that program, to delete the program, etc.). The user may position highlight region 262 on a desired recording and select the recording using an appropriate key of remote control 72.

Information about a recording selected by the user may be presented in a screen such as screen 264 as illustrated in FIG. 20b. Screen 264 may include recording information 265, which may show the date, time, and channel the program was recorded. Information 265 may also show whether a parental lock is set for the recording and what device has been designated to store the recording. The user may play the recording by selecting option 266. The user may play the selected recording from the beginning by selecting option 267. Option 268 may be selected to delete the recording from the list of recordings. Option 269 may be used to set a parental lock for the selected recording. If the selected recording is being stored on a network video storage device, the user may select option 259 to transfer the recording to a local storage device. On-screen options may be selected using a highlight region and a remote control, or by any other suitable method.

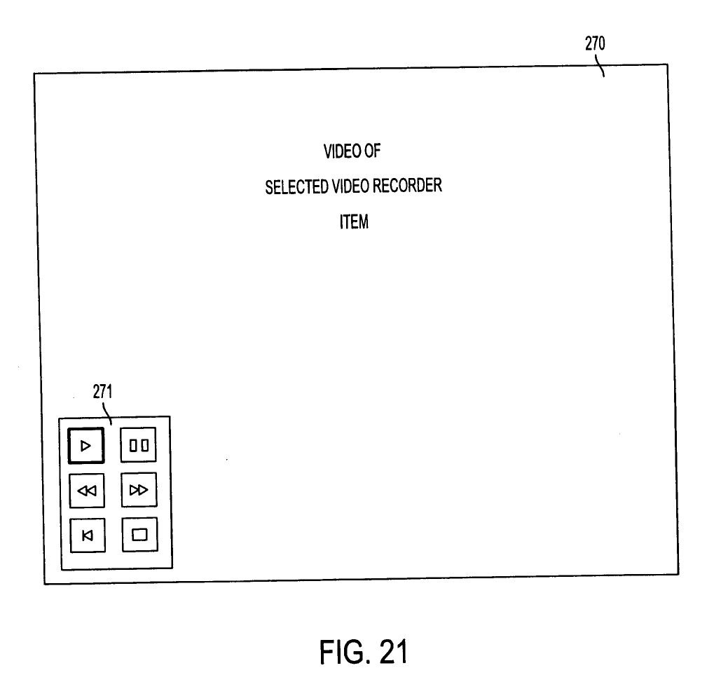

When a given recording is selected for playback, for example by selecting play option 266, a display screen such as display screen 269 of FIG. 21 may be presented. Display screen 269 may include the video 270 of the selected program that is being played back to the user and options 271 for controlling the video. Options 271 may, for example, include options that allow the user to rewind the video to the beginning, to rewind or reverse the video, to play the video, to fast-forward the video, to pause the video, or to stop the video. Control of these functions and other interactive television application functions may be supported using on-screen options, dedicated or multi-purpose keys on remote control 72 or other user devices, or other suitable arrangements involving user interface 118. When on-screen options are used, the options may be displayed in the form of one or more overlays on top of video 270 or video 270 may be provided in a reduced-size window and the options displayed outside of this window.

With the arrangement of FIGS. 20 and 21, the user can browse the user's recordings and can play back (and control the playback) of these recordings. Recordings that are stored locally on user equipment 18 may be played back by retrieving these recordings from the local hard drive or other storage on which the recordings are maintained. Recordings that are stored on the network may be played back from the network equipment on which the recording content is stored. User equipment 18 may receive such content in the form of a real-time video stream or a file download and the interactive television application may play back the received content using a display screen arrangement of the type shown in FIG. 21.

The user may record programming by indicating interest in a program for recording by highlighting a program of interest on a suitable display screen provided by the interactive television application and pressing a record key, by selecting a program for recording from a flip or browse display, by tuning to a desired program and selecting an appropriate record button, by selecting a record option from an information screen, etc. For example, the user may highlight a program in a program listings screen such as screen 138 of FIG. 8, or may display a program listing of interest on a flip display such as flip display 153 of FIG. 9 or on a browse display such as browse display 160 of FIG. 10. When the user presses a suitable remote control key such as record key 86 of FIG. 4, the interactive television application may record the desired program.

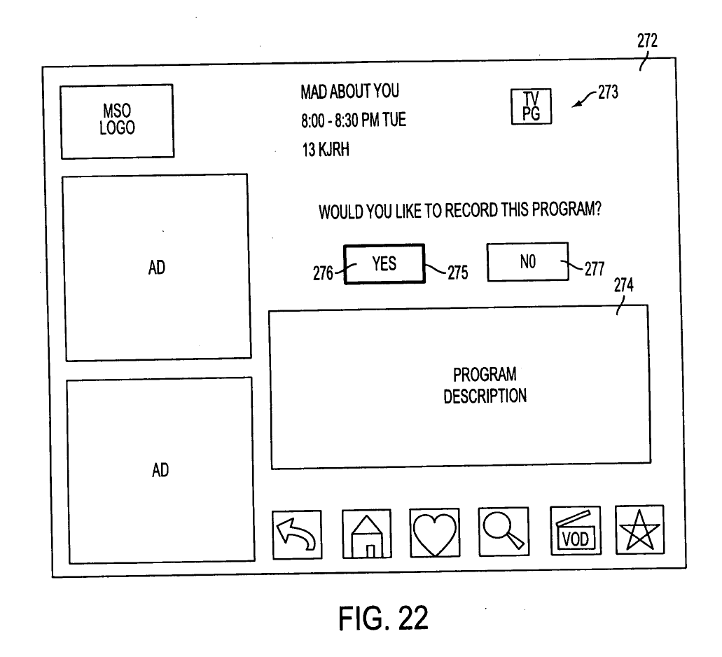

The interactive television application may automatically record the program that the user selected or may provide one or more additional confirmation and information screens after the user presses the record key 86. As an example, the interactive television application may display a screen such as record set-up screen 272 of FIG. 22. As shown in FIG. 22, screen 272 may include title and ratings information in region 273 and a program description 274. The user may be provided with information on the scheduled broadcast time for the selected program. If the user desires to record the program, the user may position highlight region 275 on top of YES option 276 and may press OK key 84. If the user does not wish to record the program, the user may position highlight 275 on top of NO option 277 and may press the OK key 84. If desired, other options such as series recording options, recording quality options, and buffer time options may be provided.

When the user directs the interactive television application to record a given program, the interactive television application will record the program using the local capabilities of user equipment 18 or using the network-based video recorder capabilities of the system 10, depending on the equipment of the user, the capabilities of system 10, and system and user settings.

After the program has been recorded, the user may use the interactive television application to view information on the user's recordings (e.g., using a display screen arrangement of the type shown in FIG. 20). These techniques for supporting recording functionality in the interactive television application are merely illustrative. Any suitable arrangement for recording (as real recordings or as virtual recordings and locally or on network equipment) may be used if desired.

The interactive television application may allow the user to establish parental control settings. For example, the user may lock a particular program, a program rating, a channel, a type of content (e.g., violent or sexual content), or may establish a parental control setting that blocks all television viewing during a particular period of time. A user may be required to enter a personal identification number (PIN) to unlock blocked content.

With one illustrative arrangement, a parent (or other suitable user) may select a program to block by highlighting the program listing for that program in a suitable program listings screen (e.g., a screen such as screen 138 of FIG. 8). After highlighting the program to be blocked, the parent may press lock key 92 on remote control 72 (FIG. 4). The parent may also access options for setting parental locks by selecting an on-screen parental control lock option provided by the interactive television application (e.g., option 234 of FIG. 17a, option 244 of FIG. 17b, etc.).

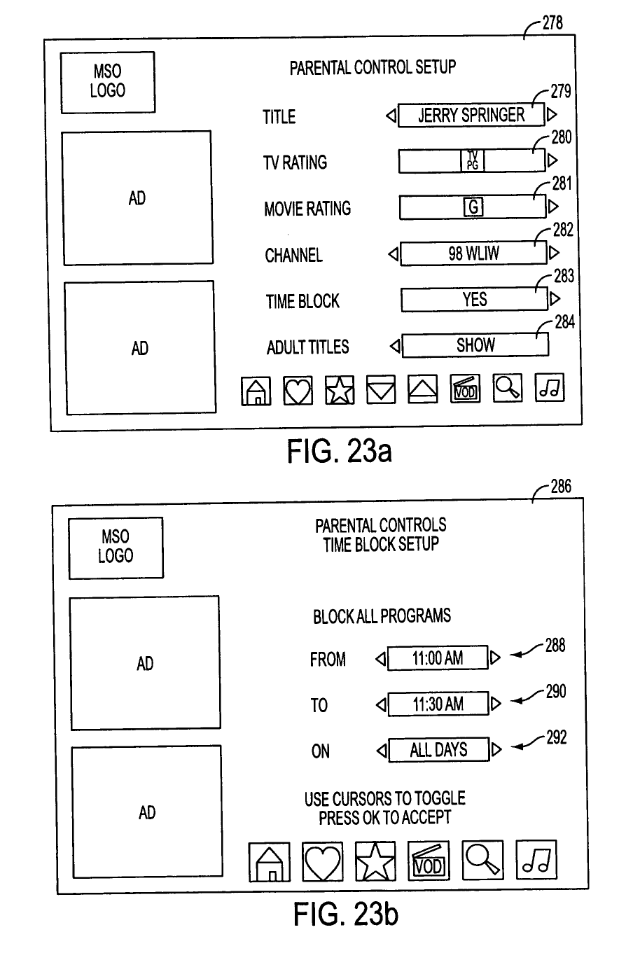

In response to a user selecting an on-screen option or remote control key to access parental control lock options, the interactive television application may display a display screen such as parental controls display screen 278 of FIG. 23a. Parental controls options may be accessed from a main menu, a selected program, or any other suitable program guide screen. Users may set parental locks for a selected program or a range of programming by selecting from various criteria. For example, users may select to block programs according to title 279, TV rating 280, movie rating 281, channel 282, or any other suitable criteria. Block ratings options 280 and 281 may allow users to block all programming with a given rating (e.g., the same rating as the selected program or a user-input rating or range of ratings). The user may be provided with other options for applying parental lock settings by selecting, for example, (YES/NO) time lock option 283. A user may also select to hide or show adult titles by selecting option 284. Other selectable options may also be provided in screen 278.

If the user has selected “YES” for time block option 183, a time block sub-menu may be provided, for example, screen 286 of FIG. 23b. The user may use the on-screen options of screen 286 to set a beginning time (option 288) and ending time (option 290) for the parental control time period. The user may use option 292 to make the parental control setting effective for all days of the week, certain groups of days (e.g., week days or weekend days), or a particular day or days. The user may press OK key 84 when finished. Other selectable options may also be provided as part of screen 286.

The parental control screens 278 and 286 of FIGS. 23a and 23b are merely illustrative. Any suitable on-screen options or other user interface arrangement may be used to allow a parent (or other user) to block (parentally-control) programming airing during a particular period of time, programming on a particular channel or channels, programming with a certain rating, individual instances of certain programs, etc.

Programming, such as audio, video, movies, and television programs, may be delivered to a plurality of users by broadcasting the programming from a television distribution facility to each user's equipment. Examples of such an arrangement are illustrated in FIG. 1, wherein television distribution facility 14 provides programming content to user equipment devices 18, 20 and 22 via communications paths, such as communication paths 26, 27 and 28. Programming content may be broadcast in accordance with a schedule, such that each program begins and ends at specified times. A viewer may watch broadcast programs according to the schedule. The broadcast programs may be delivered to the user in the form of broadcast television signals (analog and/or digital). Satellite broadcasts, cable broadcasts, and over-the-air broadcasts may be used to deliver television programming.

Users are sometimes interrupted during the delivery and viewing of broadcast television programs. To avoid missing programming content during these interruptions, the personal-video-recorder or network-based recording systems described, for example, in relation to FIGS. 2, 3 and 19-22 may be used to provide the user with playback control functions (e.g., the ability to pause, fast-forward, rewind, etc.). If desired, copies of all or some broadcast programs may be maintained by system 10. The user may control the playback of a given program while they are viewing it by interacting with an interactive streaming media version of the program rather than the original broadcast source. However, routinely providing all users in a system with their own personal interactive media stream may overly burden the media distribution capabilities of the system.

In accordance with the present invention, the interactive television application may provide the user with the ability to view broadcast television programming on the user's equipment. Broadcast television programming is delivered to the user's equipment via broadcast television signals (e.g., standard non-interactive analog and/or digital television signals). A user viewing such a broadcast television program being displayed and viewed on the user equipment may request a playback control function (e.g., pause, play, resume, rewind, skip, fast forward, slow forward, slow reverse, jump to another time point, scan, frame-by-frame advance, frame backward, restart program, etc.). In response to making such a request, the interactive television application may switch to displaying an interactive streaming version of the program from displaying the broadcast version. In some embodiments, the interactive television application may perform the switch from the broadcast version to the streaming version at substantially the same time point between the respective programs such that the switch to the streaming version may not be noticed by the user.

The delivery of streaming media content involves providing digital data streams from a remote server or television distribution facility to user equipment over communications paths such as the paths of FIG. 1. The user equipment receives the data and displays the streamed content for the viewer. This stream may be buffered and/or stored on the user equipment to improve the quality and continuity of the displayed content. For example, buffering or storing the streamed program may ensure that the program can be continuously displayed on the user equipment.

Providing programming content by streaming has several advantages over broadcast content. First, a streamed program allows the viewer to control the playback of the program, including functions such as playing, stopping, pausing, resuming, rewinding, fast-forwarding, etc. The use of these playback control functions by the user directs the interactive television application, the user equipment, and the television distribution facility to control the stream being provided to and/or displayed on the user equipment. Second, a streamed program may not require a significant amount of memory or other storage on the user equipment or associated network because the user equipment displays the received stream substantially in real-time. Accordingly, the server at television distribution facility 14, or other equipment being used to deliver the data stream, may only need to provide a portion of the program at a time to the user equipment, thereby reducing the need for memory or other storage on the user equipment and/or network. A television distribution facility may also provide separate and individualized streams to each of a plurality of users simultaneously, without being over-burdened by providing such network-based control functions to all users. For example, by providing separate streams to individual users, each user may view different programs, or even different portions of the same program. Furthermore, playback control of the display and streaming by the user, as described above, need not affect the streams being received by other users viewing their respective streaming content.

Interactive television system 10 may include television distribution facility 14 that is capable of providing both broadcast programming content and streaming programming content to a plurality of user equipment devices 18. Programming sources 12 may provide original content which may, if desired, be re-broadcast (later or in real-time) by associated television distribution facilities 14. Television distribution facilities may use server 56 (or a remote server 36 may be used) to deliver interactive media streams to users.

The user equipment devices may be capable of receiving and displaying both broadcast and streaming programming content provided via the television distribution facilities. Interactive television applications may be implemented on the user equipment in order to receive or monitor user inputs or other interactions (e.g., remote control playback commands).

The television distribution facilities may provide scheduled programming content to the plurality of users by broadcast by default. User equipment receiving the broadcast may then display the content on the user equipment for the user to watch. Those users receiving only the broadcast are generally not able to effect network-based playback control over the program they are viewing until (and if) they are switched over to the interactive media stream. The users therefore may watch the original broadcast programs in accordance with the pre-determined schedule.

If a user having user equipment configured to receive and display broadcast and streaming media content from the distribution facilities or servers wishes to initiate playback control over the programs being watched, the user may indicate this desire by interacting with the user equipment. Playback control, as used herein, includes any command that modifies how a program is provided for display on the user equipment. Such commands may include play, resume, pause, fast-forward, rewind, skip, slow forward, slow reverse, scan, frame-by-frame advance, frame reverse, jump to another time point, chapter skip, restart program, etc. These commands may be enacted by the user on a user input device, an on-screen menu or control palette, or other suitable device or interface.

For example, a user viewing a broadcast program may press a “PAUSE PROGRAM” button on their remote control or other user input device. In response, the interactive application may determine the program being watched by the viewer, as well as the point in the program at which the user pressed the “PAUSE” button. This point may be determined by noting the amount of time that has elapsed relative to the start of the program. This point may also be determined by the application by, for example, using an extrinsic index (e.g., elapsed time, frame number) or an intrinsic index (e.g., embedded markers in the programs). If desired, the user's local equipment may send the appropriate playback command to the user's associated television equipment in the form of a request that the particular television program or channel that the user is watching be switched to an interactive media stream. The user's account with their cable company or other service provider may be debited accordingly for use of this service.

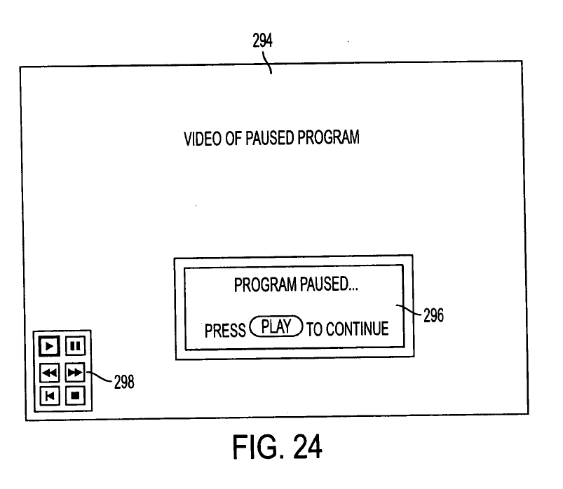

FIG. 24 shows an illustrative pause window that may be provided by interactive television application in response to the user pausing the broadcast program in accordance with various embodiments of the present invention. As depicted in FIG. 24, the interactive television application may provide visual feedback to the viewer that the program is paused by, for example, arresting or freezing an image of the program on the user equipment, such as screen 294. The application may also capture the screen image being displayed at the approximate moment the user playback control action is taken, and continue to display the captured image on the screen thereafter. In some embodiments, the interactive television application may display a window or a message, such as message window 296, overlaying the program to indicate that the program is paused. In some embodiments, the interactive television application may display a static or animated screen saver that may incorporate the frozen or captured image. The interactive television application may also display user-selectable icons or options, such as control panel 298 in FIG. 24, that allow the user to perform other playback control functions (e.g., play, fast forward, rewind, etc.).

Although the program has been paused by the user on his user equipment, the distribution facility continues broadcasting the program to all of the other receiving users. The interactive television application may allow the user to rejoin the broadcast after an interval of time. However, the user will miss portions of the program. In some embodiments of the present invention, the interactive television application may transmit the information about the broadcast program and the point at which the program was paused to a television distribution facility. The television distribution facility may then provide the user with a streaming version of the same program. For example, the television distribution facility may retrieve a streaming version of the program from a television production studio or any other suitable source and transmit the streaming version of the program to the user equipment. In some embodiments, the streaming version may start at the point at which the broadcast version was paused.

To resume viewing the program or perform any other suitable playback control action, the user may, for example, press “RESUME PROGRAM” or “PLAY PROGRAM” on the user input device (e.g., remote control), or select a corresponding playback control option on control panel 298 (or any other suitable control panel). In response to the user selecting to resume viewing the program, the interactive television application may switch from receiving and displaying the broadcast program to receiving and displaying the streaming program. As described above, because the streaming version may begin at the same point in the program at which the viewer paused the program, when the program is resumed by displaying the streaming version, the switch between versions may occur in a manner that is substantially transparent to the user. Moreover, the television distribution facility may provide individualized streams to each user such that providing streaming content to one or more users in this manner does not affect the broadcast of the original program to other users nor does it affect any streaming content being provided to other users.

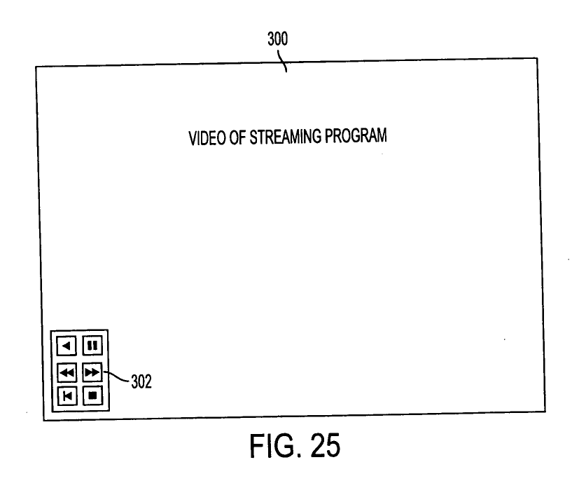

After the distribution facility provides the streaming version of the program to the user, the interactive television application may allow the user to control the playback of the program, including, for example, stopping, pausing, resuming, rewinding, fast-forwarding, or any other suitable action. The user may perform one of the playback control functions by, for example, pressing a pre-configured button on the user input device. In some embodiments, the interactive television application may provide the user with an on-screen overlay, menu or panel that includes icons or other user-selectable options. An example of such icons are depicted by control panels 298 and 302 in FIGS. 24 and 25, respectively.

In another example, a user viewing a broadcast program may press a “FAST FORWARD” button on their remote control or other user input device. In response to this command, the interactive television application may determine the program being watched by the viewer, as well as the point in the program at which the user pressed the “FAST FORWARD” button, as described above. If desired, the user's local equipment may send the appropriate playback command to the user's associated television equipment in the form of a request that the particular television program or channel that the user is watching be switched to an interactive media stream.

In response to the user's request to fast forward the program, the interactive television application may switch from receiving and displaying the broadcast program to receiving and displaying the streaming program. As described above, because the streaming version may begin at the same point in the program at which the viewer paused the program, the switch between versions may occur in a manner that is substantially transparent to the user. If the streaming version has been generated before the broadcast of the television program, the interactive application may receive and display portions of the streaming version of the program in advance of the broadcast version in response to the user's fast forward command. While the streaming version is being received and displayed on the user equipment, the user may also perform other playback control functions including, for example, stopping, pausing, resuming, rewinding, fast-forwarding, or any other suitable action. The user may also request to resume viewing the currently broadcast version. In response to this command, the interactive television application may switch from receiving and displaying the streaming version to receiving and displaying the broadcast version.

An action performed by the user that directs the interactive television application to control the playback of the program in one or more of the foregoing manners may result in a corresponding change in the program stream being provided for display on the user equipment by the distribution facility. In some embodiments, the interactive television application may allow the user to stop the stream and return to the currently broadcast program. Returning to the broadcast program may occur automatically if, for example, the user switches to another program not currently being streamed on another channel. The interactive television application may also automatically return to the broadcast program when the program being streamed has ended, when no user input has been received by the application for a certain period of time (e.g., thirty minutes, one hour, etc.), any other suitable conditions, or any other suitable combination thereof. Defining conditions under which the interactive television application may automatically stop the streaming version and return to the broadcast version, such as in the foregoing examples, serves to minimize the number of streams being provided by the remote server.

Streamed versions of programs may be provided to the distribution facility by the same content provider that is providing the broadcast version of the program. In some embodiments, these streaming versions may be provided to the television distribution facility in advance of the broadcast of the corresponding programs. In some embodiments, a source other than the original content provider may provide the streaming version to the television distribution facility. In some embodiments, streaming versions of programs may be generated from the original analog or digital broadcast version. For example, a streaming version may be generated and stored when the program is currently being broadcast. The television distribution facility or the content provider may generate a streaming version from the broadcast of the program at an earlier airing, and subsequently use this streaming version in conjunction with a later broadcast of the same program (i.e., a rerun). Such an approach may be particularly useful for programs that are being broadcast live, such as concerts, sporting events, news shows, etc., and that may be re-broadcast at one or more later times.

Playback control of the program being viewed by the user in the manner described above may be enacted by user actions or inputs. These user actions or inputs may be performed by pressing pre-configured buttons on user input devices, such as is depicted in FIG. 4, or by user selection of on-screen options. On the user input device, the user may be provided with pre-configured dedicated buttons. In addition, or alternatively, the user may select on-screen icons, thereby directing the application to perform the corresponding playback function on the program currently being viewed.

An example of on-screen options provided to the user by the interactive application is shown as playback control panel 302 on streaming video display screen 300 in FIG. 25. These icons may be normally absent from the screen, so as not to interfere or obscure the program being displayed. The interactive television application may display control panel 302 in response to the user, for example, pressing a pre-configured button on the input device. In response, the interactive television application may provide control panel 302 on the screen in a toolbar, window, overlay, pop-up menu, pull-down menu (from any side of the display screen), or any other suitable user interface construct. Control panel 302 may disappear after the user has made a selection, when the user directs the interactive television application to hide the menu, after a predetermined period of time has elapsed, or under any other suitable conditions.

In order to ensure that switching between the broadcast program and the streaming program is performed without substantial disruption to the user, the streaming version is preferably cued to begin at about the corresponding time-point in the broadcast version of the program. In response to a user pressing “PAUSE,” “REWIND,” or any other suitable playback control button on the user input device while viewing a broadcast program, the interactive television application may switch to the streaming version of the same program. In response to the user equipment receiving this command from the user, the user equipment may transmit information relating to the program to the remote server. The information may include, for example, the channel currently being viewed, the program being viewed, the time elapsed of the program, etc. Upon receiving the information from the user equipment, the remote server may determine the broadcast program the given user is currently viewing. Because the server may receive information, such as channel information, substantially instantaneously, the remote server may then retrieve the current time to determine the offset (i.e., the elapsed time) with respect to the currently-viewed broadcast program. Based at least on this information, the remote server may then begin streaming the corresponding streaming version of the program, starting at the time-point corresponding to the offset time. In some embodiments, the entire streaming version of the program is transmitted to the user equipment. Additional information may be provided by the user equipment (e.g., offset time, location, etc.) to the remote server in order to facilitate the switch between the broadcast version and the streaming version.

In another suitable approach, both the application on the user equipment and the television distribution facility may apply an index or scale to the program being viewed. The index or scale may be used to mark or identify corresponding points between the broadcast program and its equivalent streaming version. With this index or scale, the interactive television application may, for example, determine the point during the program at which the interactive television application received the indication from the user to pause the program. Using the same or convertible scale, this information may then be communicated to the television distribution facility to identify the corresponding point in the streaming version of the program. Accordingly, the television distribution facility may then start the streaming program at this point, such that when the user resumes viewing the program, the streaming version will begin at substantially the same point at which the broadcast program was paused without any discrepancy or disruption apparent to the viewer.

The indices or scales in the programs may be intrinsic or extrinsic. Extrinsic indices may include elapsed time or the frame count of the program. For example, the interactive television application may determine the amount of time that has elapsed or the number of frames that have been displayed relative to a reference point in the program. Once either of these parameters are communicated to the television distribution facility or remote server, the corresponding point may be found in the streaming version of the program and the stream may begin at this point. The use of an extrinsic index may not require modification of the broadcast program.

In some embodiments, an intrinsic index or scale may be used in which markers are embedded in the program content. Markers may include, for example, watermarks, visual cues, sound cues, or any other suitable indicators. These embedded markers may be invisible or inconspicuous when the program is being displayed to the user. In some embodiments, the interactive television application may remove or filter the embedded markers before displaying the program. Similar to the extrinsic indices, the interactive television application may use the embedded markers to determine points in both the broadcast and streaming versions of a program. The embedded markers in a program may be positioned at fixed intervals (e.g., every five minutes), or may correspond to significant parts of the program (e.g., every chapter or every commercial break).

The interactive television application may also interpolate between the embedded markers to achieve a higher resolution. In some embodiments, the interactive television application may use a combination of intrinsic and extrinsic indices, where the broadcast program uses one index and the streaming programming uses the other index. Either or both the interactive television application and the television distribution facility may use conversion formulae or look-up tables to determine the equivalence between the intrinsic and extrinsic indices in order to identify corresponding points in the programs.

Although the features associated with switching between broadcast and streaming programming described herein are capable of being provided to any number of users having the appropriate user equipment, such features may instead be available as part of a premium service. In some embodiments, these features may be available on demand, but charging the user for each use. For example, the content provider and/or the cable company may provide the user with an opportunity to subscribe to a service that provides these features. Non-subscribers will continue to receive the broadcast programming content, and may continue to view it in the traditional manner, but may not be provided nor use any of the playback control functions. For subscribers, the content provider may enable and/or authorize the user equipment and the interactive television application therein to provide these features to the user, including the ability to receive and display streamed programs. These features may be limited to subscribers by requiring verification of the user equipment and/or application when the user attempts to use these features. In some embodiments, these features may require specialized equipment and/or applications for the functionality to be provided, such as special user input devices.

In some embodiments, the content provider may allow the user to subscribe to a service in which these playback control features are available only for a smaller or narrower subset of programs or channels. The user may request the switching feature be made available for a given show, channel, genre, or the like. For example, a user may not need playback control while watching a network comedy or drama. but may have the features available for viewing movies, sporting events, concerts, awards shows, etc., wherein the user is more likely to be interrupted, and/or wherein such interruptions may be more deleterious to his viewing experience.

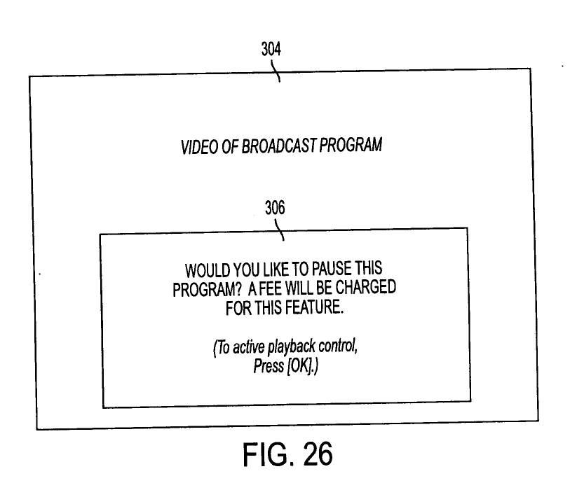

If desired, the interactive television application may allow the user to use these features on demand, but require payment for each use. For example, the user's subscription agreement may provide for a charge to be applied to the user's account for each activation or use of this feature. In response to the interactive television application performing an action, such as pausing a program being viewed, a charge may be automatically applied to the user's account. The user may be notified of the charge, and/or the application may first require confirmation from the user that the user approves of the charge. FIG. 26 shows an illustrative message window that may be provided to the user in accordance with various embodiments of the present invention. Message window 306 on an illustrative display screen 304 may prompt the user with the question “Would you like to pause this program?” Message window 306 may also inform the user that a fee (e.g., a fee per use, a subscription fee, etc.) will be charged for using this feature. A user may prefer to have these features available on-demand, since it would require less planning by the user (e.g., may not require prior subscription to the appropriate service), and therefore the user may be willing to use it more frequently.

In some embodiments in which playback control features are available only to certain subsets or types of broadcast programs, the interactive television application may provide an indicator to the user with an indicator relating to which programs have these features. For example, the interactive television application may provide an icon, a short message, a distinct color or pattern, or any other suitable indicator in conjunction or association with the applicable program. For example, such indicators may be displayed in a program guide (either interactive or non-interactive), a program listings screen, a grid screen, a program information screen, a flip screen, an overlay on the video of the broadcast program, or any other suitable locations by the interactive television application.

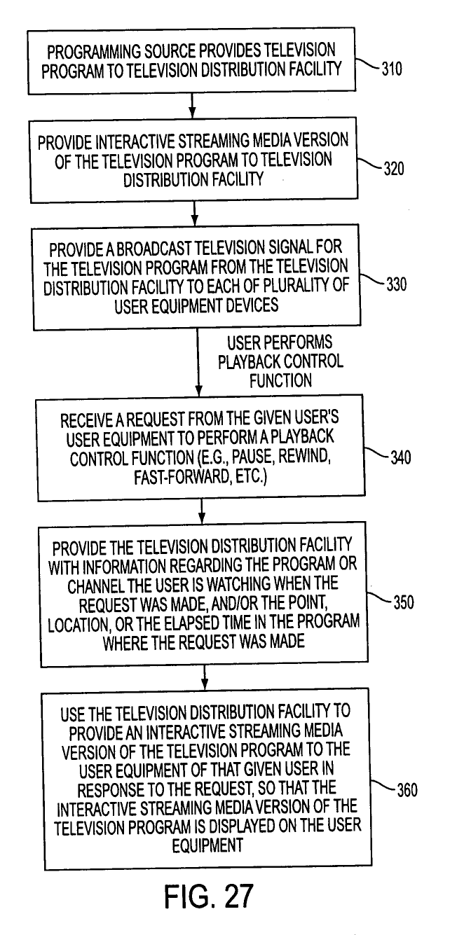

FIG. 27 shows an illustrative method for switching from a broadcast program to a streaming program in response to a user's request in accordance with various embodiments of the present invention. At step 310, a programming source or content provider provides a television program to a television distribution facility or other remote server.

At step 320, the television distribution facility is provided with an interactive streaming version of the television program. This streaming version may be provided separately from the television program by the content provider or programming source, by a provider other than the content provider or programming source, by a television distribution facility or other remote server that generates the streaming version from an earlier broadcast of the television program, or by any other suitable provider. In some embodiments, the sequence of steps 310 and 320 may be modified, where the streaming version may be provided before or at substantially the same time as the television program.

At step 330, the interactive television application receives the broadcast program from the television distribution facility or other remote server and displays the broadcast program to the user on the user equipment. During the broadcast, a given user may be provided with the opportunity to perform or initiate a playback control function, such as pause, resume, rewind, fast-forward, etc. Such functions may be performed on the given user's remote control, on-screen menu or control panel, or using any other suitable input device. After the user performs a playback control function, the television distribution facility may receive this request from the user equipment at step 340. At step 350, the interactive television application may also provide the television distribution facility with information regarding the program or channel the user is watching when the request was made, and/or the point, location, or the elapsed time in the program where the request was made.

At step 340, the television distribution facility receives the request from the given user to perform a playback control function. In response to the request, the television distribution facility may provide a streaming media version of the television program to the user equipment of the user (step 360). The interactive television application on the user equipment may replace the broadcast version and display the streaming media version. The streaming version may be interactive and provide the user with playback controls (e.g., play, pause, resume, fast-forward, rewind, jump, etc.).

In some embodiments, the interactive television application may allow the user to return to viewing the broadcast program. In some embodiments, the interactive television application may automatically return to displaying the broadcast program. For example, the interactive television application may automatically return to the broadcast program in response to the user making a selection, after a predetermined period of time has elapsed, or under any other suitable conditions.

Thus, systems and methods for providing a user with playback control functions while viewing a broadcast television program are provided. One skilled in the art will appreciate that the present invention can be practiced by other than the described embodiments, which are presented for purposes of illustration and not of limitation, and the present invention is limited only by the claims which follow.

1. A method for providing a user with playback options while viewing a broadcast television program on user equipment, the method comprising:
providing the broadcast television program to the user equipment;
receiving a request from the user to perform a playback option while viewing the television program that is currently being broadcast; and
providing a streaming version of the broadcast television program to the user equipment instead of the broadcast television program in response to the received request, wherein in the streaming version of the broadcast television program is generated before the broadcast of the television program.

2. The method of claim 1 further comprising charging the user a fee when the user requests to perform the playback option.

3. The method of claim 1 further comprising receiving a request from the user to return to the broadcast of the broadcast television program.

4. The method of claim 1 further comprising automatically returning to the broadcast of the broadcast television program after the end of the streaming version of the television program.

5. The method of claim 1 further comprising automatically returning to the broadcast of the broadcast television program after a predetermined amount of time.

6. The method defined in claim 1, wherein the generated streaming version of the broadcast television program is substantially the same as the broadcast television program.

7. The method of claim 1, wherein the playback option is selected from the group consisting of: pause, resume, play, fast forward, rewind, slow forward, slow reverse, jump to another time point, scan, frame-by-frame advance, frame backward, skip, and restart program.

8. The method of claim 1, wherein the providing the streaming version comprises determining the time point in the broadcast television program at which the user requests to perform the playback option.

9. The method of claim 8, wherein the providing the streaming version further comprises providing the streaming version of the television program at substantially the same time point.

10. The method of claim 8, wherein the determining the time point comprises determining the amount of elapsed time of the broadcast at which the user requests to perform the playback option.

11. The method of claim 8, wherein the broadcast television program is associated with an index of time points, and wherein the determining the time point comprises using the associated index to determine the time point at which the user requests to perform the playback option.

12. The method defined in claim 11, wherein the associated index includes a plurality of embedded markers in the broadcast television program, and wherein the using the associated index comprises determining the time point corresponding to the embedded marker at which the user requests to perform the playback option.

13. The method defined in claim 1, wherein the streaming version is the entire broadcast television program.

14. The method defined in claim 1, wherein the providing the streaming version includes detecting at least one embedded marker.

15. A system for providing a user with playback options while viewing a broadcast television program on user equipment, the system comprising:
a television distribution facility configured to:
provide the broadcast television program to the user equipment;
receive a request from the user to perform a playback option while viewing the television program that is currently being broadcast; and
provide a streaming version of the broadcast television program to the user equipment instead of the broadcast television program in response to the received request, wherein in the streaming version of the broadcast television program is generated before the broadcast of the television program.

16. The system of claim 15, wherein the television distribution facility is further configured to charge the user a fee when the user requests to perform the playback option.

17. The system of claim 15, wherein the television distribution facility is further configured to receive a request from the user to return to the broadcast of the broadcast television program.

18. The system of claim 15, wherein the television distribution facility is further configured to automatically return to the broadcast of the broadcast television program after the end of the streaming version of the television program.

19. The system of claim 15, wherein the television distribution facility is further configured to automatically return to the broadcast of the broadcast television program after a predetermined amount of time.

20. The system of claim 15, wherein the generated streaming version of the broadcast television program is substantially the same as the broadcast television program.

21. The system of claim 15, wherein the playback option is selected from the group consisting of: pause, resume, play, fast forward, slow forward, slow reverse, rewind, jump to another time point, scan, frame-by-frame advance, frame backward, skip, and restart program.

22. The system of claim 15, wherein the television distribution facility, when configured to provide the streaming version, is configured to determine the time point in the broadcast television program at which the user requests to perform the playback option.

23. The system of claim 22, wherein the television distribution facility, when configured to provide the streaming version, is configured to provide the streaming version of the television program at substantially the same time point.

24. The system of claim 22, wherein the television distribution facility, when configured to determine the time point, is configured to determine the amount of elapsed time of the broadcast at which the user requests to perform the playback option.

25. The system of claim 22, wherein the broadcast television program is associated with an index of time points, and wherein the television distribution facility, when configured to determine the time point, is configured to use the associated index to determine the time point at which the user requests to perform the playback option.

26. The system of claim 25, wherein the associated index includes a plurality of embedded markers in the broadcast television program, and wherein the television distribution facility, when configured to use the associated index, is configured to determine the time point corresponding to the embedded marker at which the user requests to perform the playback option.

27. The system of claim 15, wherein the streaming version is the entire broadcast television program.

28. The system of claim 15, wherein the providing the streaming version includes detecting at least one embedded marker.

29. A system for providing a user with playback options while viewing a broadcast television program on user equipment, the system comprising:
means for providing the broadcast television program to the user equipment;
means for receiving a request from the user to perform a playback option while viewing the television program that is currently being broadcast; and
means for providing a streaming version of the broadcast television program to the user equipment instead of the broadcast television program in response to the received request, wherein in the streaming version of the broadcast television program is generated before the broadcast of the television program.

30. The system of claim 29 further comprising means for charging the user a fee when the user requests to perform the playback option.

31. The system of claim 29 further comprising means for receiving a request from the user to return to the broadcast of the broadcast television program.

32. The system of claim 29 further comprising means for automatically returning to the broadcast of the broadcast television program after the end of the streaming version of the television program.

33. The system of claim 29 further comprising means for automatically returning to the broadcast of the broadcast television program after a predetermined amount of time.

34. The system of claim 29, wherein the generated streaming version of the broadcast television program is substantially the same as the broadcast television program.

35. The system of claim 29, wherein the playback option is selected from the group consisting of: pause, resume, play, fast forward, slow forward, slow reverse, rewind, jump to another time point, scan, frame-by-frame advance, frame backward, skip, and restart program.

36. The system of claim 29, wherein the means for providing the streaming version comprises means for determining the time point in the broadcast television program at which the user requests to perform the playback option.

37. The system of claim 36, wherein the means for providing the streaming version further comprises means for providing the streaming version of the television program at substantially the same time point.

38. The system of claim 36, wherein the means for determining the time point comprises means for determining the amount of elapsed time of the broadcast at which the user requests to perform the playback option.

39. The system of claim 36, wherein the broadcast television program is associated with an index of time points, and wherein the means for determining the time point comprises means for using the associated index to determine the time point at which the user requests to perform the playback option.

40. The system of claim 39, wherein the associated index includes a plurality of embedded markers in the broadcast television program, and wherein the means for using the associated index comprises means for determining the time point corresponding to the embedded marker at which the user requests to perform the playback option.

41. The system of claim 29, wherein the streaming version is the entire broadcast television program.

42. The system of claim 29, wherein the providing the streaming version includes detecting at least one embedded marker.

43. Machine-readable media for use in an television distribution facility, in which the television distribution facility provides a user with playback options while viewing a broadcast television program on user equipment, wherein the media is encoded with machine-readable instructions for performing the method comprising:
providing the broadcast television program to the user equipment;
receiving a request from the user to perform a playback option while viewing the television program that is currently being broadcast; and
providing a streaming version of the broadcast television program to the user equipment instead of the broadcast television program in response to the received request, wherein in the streaming version of the broadcast television program is generated before the broadcast of the television program.

44. The machine-readable media of claim 43, wherein the method further comprises charging the user a fee when the user requests to perform the playback option.

45. The machine-readable media of claim 43, wherein the method further comprises receiving a request from the user to return to the broadcast of the broadcast television program.

46. The machine-readable media of claim 43, wherein the method further comprises automatically returning to the broadcast of the broadcast television program after the end of the streaming version of the television program.

47. The machine-readable media of claim 43, wherein the method further comprises automatically returning to the broadcast of the broadcast television program after a predetermined amount of time.

48. The machine-readable media of claim 43, wherein the generated streaming version of the broadcast television program is substantially the same as the broadcast television program.

49. The machine-readable media of claim 43, wherein the playback option is selected from the group consisting of: pause, resume, play, fast forward, slow forward, slow reverse, rewind, jump to another time point, scan, frame-by-frame advance, frame backward, skip, and restart program.

50. The machine-readable media of claim 43, wherein the providing the streaming version comprises determining the time point in the broadcast television program at which the user requests to perform the playback option.

51. The machine-readable media of claim 50, wherein the providing the streaming version further comprises providing the streaming version of the television program at substantially the same time point.

52. The machine-readable media of claim 50, wherein the determining the time point comprises determining the amount of elapsed time of the broadcast at which the user requests to perform the playback option.

53. The machine-readable media of claim 50, wherein the broadcast television program is associated with an index of time points, and wherein the determining the time point comprises using the associated index to determine the time point at which the user requests to perform the playback option.

54. The machine-readable media of claim 53, wherein the associated index includes a plurality of embedded markers in the broadcast television program, and wherein the using the associated index comprises determining the time point corresponding to the embedded marker at which the user requests to perform the playback option.

55. The machine-readable media of claim 43, wherein the streaming version is the entire broadcast television program.

56. The machine-readable media of claim 43, wherein the providing the streaming version includes detecting at least one embedded marker.
